(19) United States
(12) Patent Application Publication
(10) Pub. No.: US 2013/0026253 A1
(43) Pub. Date: Jan. 31, 2013

(54) Systems and Methods for Dispensing Texture Material Using Dual Flow Adjustment

(71) Applicants: Randal W. Hanson, Bellingham, WA (US); Darrel Vander Griend, Everson, WA (US); Jason Morris, Bellingham, WA (US); Gary Hardwick, Bellingham, WA (US); John Kordosh, Simi Valley, CA (US)

(72) Inventors: Randal W. Hanson, Bellingham, WA (US); Darrel Vander Griend, Everson, WA (US); Jason Morris, Bellingham, WA (US); Gary Hardwick, Bellingham, WA (US); John Kordosh, Simi Valley, CA (US)

(73) Assignee: HOMAX PRODUCTS, INC., Bellingham, WA (US)

(21) Appl. No.: 13/560,949

(22) Filed: Jul. 27, 2012

Related U.S. Application Data
(60) Provisional application No. 61/513,401, filed on Jul. 29, 2011.
(60) Provisional application No. 61/664,678, filed on Jun. 26, 2012.

(51) Int. Cl. B05B 7/14

(52) U.S. Cl. 239/325

(57) ABSTRACT

An aerosol dispenser for dispensing stored material in a spray comprises a container, a conduit, and first and second adjustment systems. The container defines a chamber containing the stored material and pressurized material. The conduit defines a conduit passageway having a conduit inlet and a conduit outlet. The conduit inlet is arranged within the chamber and the conduit outlet is arranged outside of the chamber. The first adjustment system is arranged to vary a flow of stored material along the conduit passageway and is arranged between the conduit inlet and the conduit outlet. The second adjustment system arranged to vary a flow of stored material along the conduit passageway and is arranged between the first adjustment system and the conduit outlet.

### RELATED APPLICATIONS

This application (Attorney's Ref. No. P217003) claims benefit of U.S. Provisional Application Ser. Nos. 61/513,401 filed Jul. 29, 2011, and 61/664,678 filed Jun. 26, 2012, the contents of which are incorporated herein by reference.

### TECHNICAL FIELD

This application relates to the dispensing of texture material and, more particularly, to systems and methods for dispensing small amounts of texture material to an un-textured portion of a target surface such that an applied texture pattern of the texture material substantially matches a preexisting texture pattern on a textured portion of the target surface.

### BACKGROUND

The present invention generally relates to systems and methods for applying texture material to an interior surface such as a wall or ceiling. In particular, buildings are typically constructed with a wood or metal framework. To form interior wall and ceiling surfaces, drywall material is attached to the framework. Typically, at least one primer layer and at least one paint layer is applied to the surface of the drywall material to form a finished wall surface.

For aesthetic and other reasons, a bumpy or irregular texture layer is often formed on the drywall material after the drywall material has been primed and before it has been painted. The appearance of the texture layer can take a number of patterns. As its name suggests, an “orange peel” texture pattern generally has the appearance of the surface of an orange and is formed by a spray of relatively small droplets of texture material applied in a dense, overlapping pattern. A “splatter” texture pattern is formed by larger, more spaced out droplets of texture material. A “knockdown” texture patter is formed by spraying texture material in larger droplets (like a “splatter” texture pattern) and then lightly working the surfaces of the applied droplets with a knife or scraper so that the highest points of the applied droplets are flattened. In some situations, a visible aggregate material such as polystyrene chips is added to the texture material to form what is commonly referred to as an “acoustic” or “popcorn” texture pattern. The principles of the present invention are of primary significance when applied to a texture material without visible aggregate material.

For larger applications, such as a whole room or structure, the texture layer is typically initially formed using a commercial texture sprayer. Commercial texture sprayers typically comprise a spray gun, a hopper or other source of texture material, and a source of pressurized air. The texture material is mixed with a stream of pressurized air within the texture gun, and the stream of pressurized air carries the texture material in droplets onto the target surface to be textured. Commercial texture sprayers contain numerous points of adjustment (e.g., amount of texture material, pressure of pressurized air, size of outlet opening, etc.) and thus allow precise control of the texture pattern and facilitate the quick application of texture material to large surface areas. However, commercial texture sprayers are expensive and can be difficult to set up, operate, and clean up, especially for small jobs where overspray may be a problem.

For smaller jobs and repairs, especially those performed by non-professionals, a number of “do-it-yourself” (DIY) products for applying texture material are currently available in the market. Perhaps the most common type of DIY texturing products includes aerosol systems that contain texture material and a propellant. Aerosol systems typically include a container, a valve, and an actuator. The container contains the texture material and propellant under pressure. The valve is mounted to the container selectively to allow the pressurized propellant to force the texture material out of the container. The actuator defines an outlet opening, and, when the actuator is depressed to place the valve in an open configuration, the pressurized propellant forces the texture material out of the outlet opening in a spray. The spray typically approximates only one texture pattern, so it was difficult to match a variety of perhaps unknown preexisting texture patterns with original aerosol texturing products.

A relatively crude work around for using an aerosol texturing system to apply more than one texture pattern is to reduce the pressure of the propellant material within the container prior to operating the valve. In particular, when maintained under pressure within the container, typical propellant materials exist in both a gas phase and in a liquid phase. The propellant material in the liquid phase is mixed with the texture material, and the texture material in the gas state pressurizes the mixture of texture material and liquid propellant material. When the container is held upright, the liquid contents of the container are at the bottom of the container chamber, while the gas contents of the container collect at the top of the container chamber. A dip tube extends from the valve to the bottom of the container chamber to allow the propellant in the gas phase to force the texture material up from the bottom of the container chamber and out of the outlet opening when the valve is opened. To increase the size of the droplets sprayed out of the aerosol system, the container can be inverted, the valve opened, and the gas phase propellant material allowed to flow out of the aerosol system, reducing pressure within the container chamber. The container is then returned upright and the valve operated again before the pressure of the propellant recovers such that the liquid contents are forced out in a coarser texture pattern. This technique of adjusting the applied texture pattern result in only a limited number of texture patterns that are not highly repeatable and can drain the can of propellant before the texture material is fully dispensed.

A more refined method of varying the applied texture pattern created by aerosol texturing patterns involved adjusting the size of the outlet opening formed by the actuator structure. Initially, it was discovered that the applied texture pattern could be varied by attaching one of a plurality of straws or tubes to the actuator member, where each tube defined an internal bore of a different diameter. The straws or tubes were sized and dimensioned to obtain fine, medium, and coarse texture patterns appropriate for matching a relatively wide range of pre-existing texture patterns. Additional structures such as caps and plates defining a plurality of openings each having a different cross-sectional area could be rotatably attached relative to the actuator member to change the size of the outlet opening. More recently, a class of products has been developed using a resilient member that is deformed to alter the size of the outlet opening and thus the applied texture pattern.

Existing aerosol texturing products are acceptable for many situations, especially by DIY users who do not expect perfect or professional results. Professional users and more demanding DIY users, however, will sometimes forego aerosol texturing products in favor of commercial texture sprayers because of the control provided by commercial texture sprayers.

The need thus exists for improved aerosol texturing systems and methods that can more closely approximate the results obtained by commercial texture sprayers.

### SUMMARY

An aerosol dispenser for dispensing stored material in a spray comprises a container, a conduit, and first and second adjustment systems. The container defines a chamber containing the stored material and pressurized material. The conduit defines a conduit passageway having a conduit inlet and a conduit outlet. The conduit inlet is arranged within the chamber and the conduit outlet is arranged outside of the chamber. The first adjustment system is arranged to vary a flow of stored material along the conduit passageway and is arranged between the conduit inlet and the conduit outlet. The second adjustment system arranged to vary a flow of stored material along the conduit passageway and is arranged between the first adjustment system and the conduit outlet.

The present invention may also be embodied as a method of dispensing stored material in a spray comprising the following steps. The stored material and pressurized material are arranged in a chamber. A conduit is arranged such that a conduit inlet is arranged within the chamber and a conduit outlet is arranged outside of the chamber. A flow of stored material is varied at a first location along the conduit passageway. The first location is arranged between a conduit inlet defined by the conduit passageway and a conduit outlet defined by the conduit passageway. The flow of stored material is varied at a second location along the conduit passageway. The third location is arranged between the first location and the conduit outlet.

The present invention may also be embodied as an aerosol dispensing system for dispensing stored material in a spray comprising a container, a conduit, a valve assembly, and first and second adjustment members. The container defines a chamber containing the stored material and pressurized material. The conduit defines a conduit passageway having a conduit inlet and a conduit outlet. The conduit inlet is arranged within the chamber, and the conduit outlet is arranged outside of the chamber. The valve assembly is arranged selectively to allow and prevent flow of stored material along the conduit passageway. The first adjustment member arranged to vary a flow of stored material along the conduit passageway and is arranged between the conduit inlet and the conduit outlet. The second adjustment member arranged to vary a flow of stored material along the conduit passageway and is arranged between the first adjustment member and the conduit outlet.

### DESCRIPTION OF THE DRAWINGS

FIG. 1 schematically represents a first example general class of aerosol texturing system of the present invention;

FIG. 2 is a side elevation view of a second example aerosol texturing system of the present invention;

FIG. 3 is a side elevation, partial section view a first adjustment system of the second example aerosol texturing system in a closed configuration;

FIG. 3A is a front elevation view of a second adjustment member of the second example aerosol texturing system;

FIG. 4 is a partial section view of the first adjustment system of the second example aerosol texturing system in an intermediate configuration;

FIG. 5 is a partial section view of the first adjustment system of the second example aerosol texturing system in a fully open configuration;

FIG. 6 is a side elevation view of a third example aerosol texturing system of the present invention;

FIG. 7 is a side elevation, section view of an actuator member and first and second adjustment systems of the third example aerosol texturing system, with the second adjustment system including a plurality of straw members;

FIG. 8 is top perspective view illustrating an example actuator assembly of the third example aerosol texturing system;

FIG. 9 is a top plan view of the example actuator assembly of the third example aerosol texturing system;

FIG. 10 is a top perspective, assembly view illustrating a portion of the first example adjustment system of the third example aerosol texturing system;

FIG. 11 is a bottom perspective view illustrating an adjustment plate of the first example adjustment system of the third example aerosol texturing system;

FIG. 12 is a rear elevation view of a portion of the actuator assembly of the third example aerosol texturing system;

FIGS. 13 and 14 are a rear elevation view of a portion of FIG. 12 illustrating the movement of the adjustment plate;

FIGS. 15A and 15B are partial section views illustrating movement of an actuator member from a closed position to a first intermediate position;

FIGS. 16A and 16B are partial section views illustrating movement of the actuator member from a closed position to a second intermediate position;

FIGS. 17A and 17B are partial section views illustrating movement of the actuator member from a closed position to a fully open position;

FIG. 18 is a side elevation view of a fourth example aerosol texturing system of the present invention;

FIG. 19 is a side elevation section view of an actuator member and first and second adjustment systems of the fourth example aerosol texturing system, with the actuator member in a closed position;

FIG. 19 is a side elevation section view of the actuator member and first and second adjustment systems of the fourth example aerosol texturing system, with the first adjustment system in a fully open configuration and the actuator member in a closed position;

FIG. 20 is a side elevation section view of the actuator member and first and second adjustment systems of the fourth example aerosol texturing system, with the first adjustment system in a fully open configuration and the actuator member in a fully open position;

FIG. 21 is a side elevation section view of the actuator member and first and second adjustment systems of the fourth example aerosol texturing system, with the first adjustment system in an intermediate configuration and the actuator member in a closed position;

FIG. 22 is a side elevation section view of the actuator member and first and second adjustment systems of the fourth example aerosol texturing system, with the first adjustment system in a fully open configuration and the actuator member in an intermediate position;

FIG. 23 schematically represents a second example general class of aerosol texturing system of the present invention;

FIG. 24 is a side elevation view of a fifth example aerosol texturing system of the present invention;

FIG. 25 is a side elevation section view of an actuator member and first and second adjustment systems of the fifth example aerosol texturing system taken along lines 25-25 in FIG. 26, with the actuator member in a closed position;

FIG. 26 is a front elevation section view of an actuator member and first adjustment system of the fifth example aerosol texturing system taken along lines 26-26 in FIG. 25, with the actuator member in a closed position and the first example adjustment system in an intermediate configuration;

FIG. 27 is a side elevation section view of an actuator member and first and second adjustment systems of the fifth example aerosol texturing system, with the actuator member in a closed position and the first example adjustment system in a terminal configuration;

FIG. 28 is a side elevation view of a sixth example aerosol texturing system of the present invention;

FIG. 29 is a side elevation section view of an actuator member and first and second adjustment systems of the sixth example aerosol texturing system taken along lines 29-29 in FIG. 30, with the actuator member in a closed position;

FIG. 30 is a front elevation section view of an actuator member and first adjustment system of the sixth example aerosol texturing system taken along lines 26-26 in FIG. 25, with the actuator member in a closed position and the first example adjustment system in an intermediate configuration;

FIG. 31 is a side elevation section view of an actuator member and first adjustment systems of the sixth example aerosol texturing system, with the actuator member in a closed position and the first example adjustment system in a terminal configuration;

FIG. 32 is a side elevation view of a seventh example aerosol texturing system of the present invention;

FIG. 33 is a side elevation section view of an actuator member and first and second adjustment systems of the seventh example aerosol texturing system, with the first adjustment system in a fully open configuration and the actuator member in a closed position;

FIG. 34 is a side elevation section view of the actuator member and first and second adjustment systems of the seventh example aerosol texturing system, with the first adjustment system in an intermediate configuration and the actuator member in a closed position;

FIG. 35 is a side elevation view of a eighth example aerosol texturing system of the present invention;

FIG. 36 is a side elevation section view of an actuator member and first and second adjustment systems of the eighth example aerosol texturing system, with the first example adjustment system in a terminal configuration;

FIG. 37 is a front elevation section view of an actuator member and first adjustment system of the eighth example aerosol texturing system taken along lines 37-37 in FIG. 36, with the first example adjustment system in the terminal configuration;

FIG. 38 is a side elevation section view of an actuator member and first and second adjustment systems of the eighth example aerosol texturing system, with the first example adjustment system in an intermediate configuration;

FIG. 39 is a side elevation view of a ninth example aerosol texturing system of the present invention;

FIG. 40 is a side elevation section view of an actuator member and first and second adjustment systems of the ninth example aerosol texturing system, with the first example adjustment system in a full open configuration;

FIG. 41 is a front elevation section view of an actuator member and first adjustment system of the ninth example aerosol texturing system taken along lines 46-46 in FIG. 40, with the first example adjustment system in the fully open configuration; and

FIG. 42 is a side elevation section view of an actuator member and first and second adjustment systems of the ninth example aerosol texturing system, with the first example adjustment system in an intermediate configuration.

### DETAILED DESCRIPTION

The present invention may be embodied in many forms, and several examples of aerosol dispensing systems of the present invention will be discussed below. In particular, the Applicant will initially describe a first example class of aerosol systems and a number of example aerosol dispensing systems within the first class. The Applicant will then describe a second example class of aerosol systems and a number of example aerosol dispensing systems within that second class.

### I. First Example Class of Aerosol Dispensing Systems

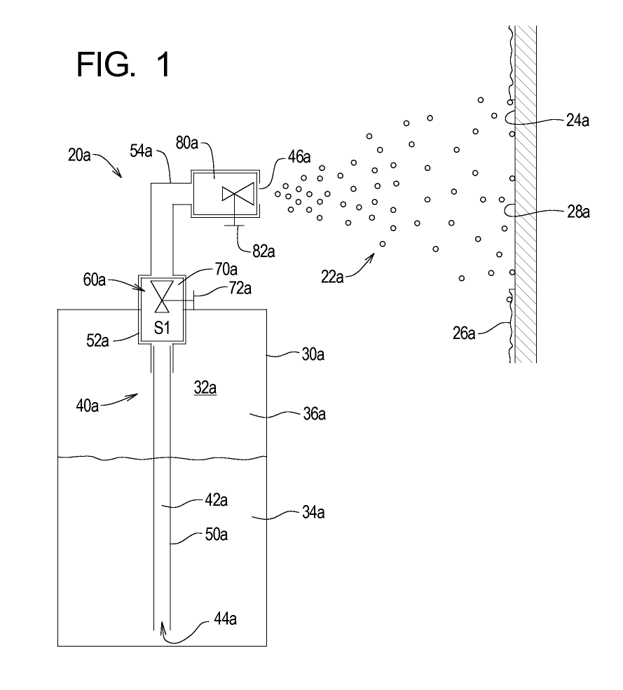

Referring initially to FIG. 1 of the drawing, depicted at 20a therein is a first example aerosol dispensing system constructed in accordance with, and embodying, the principles of the present invention. The first example dispensing system is adapted to spray droplets of dispensed material 22a onto a target surface 24a. The example target surface 24a has a textured portion 26a and an un-textured portion 28a. Accordingly, in the example use of the dispensing system 20a depicted in FIG. 1, the dispensed material 22a is or contains texture material, and the dispensing system 20a is being used to form a coating on the un-textured portion 28a having a desired texture pattern that substantially matches a pre-existing texture pattern of the textured portion 26a.

FIG. 1 further illustrates that the example dispensing system 20a comprises a container 30a defining a chamber 32a in which stored material 34a and pressurized material 36a are contained. The stored material 34a is a mixture of texture material and propellant material in liquid phase, while the pressurized material is propellant material in gas phase.

A typical texture material forming a part of the dispensed material 22a and/or stored material 34a will comprise a base or carrier, a binder, a filler, and, optionally, one or more additives such as surfactants, biocides and thickeners. Examples of the base or carrier include water, solvent (oil-based texture material) such as xylene, toluene, acetone, methyl ethyl ketone, and combinations of water and water soluble solvents. Examples of binders include starch, polyvinyl alcohol and latex resins (water-based systems) and a wide variety of polymers such as ethylene vinyl acetate, thermoplastic acrylics, styrenated alkyds, etc. (solvent-based systems.). Examples of fillers include calcium carbonate, titanium dioxide, attapulgite clay, talc, magnesium aluminum silicate, etc.

The stored material 34a will also comprise a liquid phase propellant material, and the pressurized material will typically comprise a gas phase propellant material. The following propellant materials are appropriate for use as the propellant material forming the stored material 34a and the pressurized material 36a: dimethyl ether, propane, butane, isobutene, difluoroethane, and tetrafluoroethane.

The following Tables A-1, A-2, and A-3 and Tables A-4 and A-5 attached hereto as Exhibit A contain example formulations of the texture material that may be used to form the dispensed material 22a and stored material 34a of the first example aerosol dispensing 20a.

TABLE A-1
(Solvent Based)

| | | First | Second | Third |
|---|---|---|---|---|
| Material | Purpose | Example | Example | Example |
| Solvent | Base | 35% | 30-40% | 20-60% |
| Pigment | Filler | 60% | 55-65% | 40-80% |
| Resin | Binder | 2.5% | 1-5% | 0.5-15% |

To the example texture material described in Table A-1 is added propellant material in the form of a propane/butane/isobutane blend. A first range of approximately 10-20% by weight of the propellant material is added to the example texture material of Table A-1, but the propellant material should in any event be within a second range of approximately 5-25% by weight of the propellant material.

TABLE A-2
(Knockdown)

| | | First | Second | Third |
|---|---|---|---|---|
| Material | Purpose | Example | Example | Example |
| Water | Base | 48% | 45-55% | 40-60% |
| Pigment | Filler | 50% | 45-55% | 40-60% |
| Resin | Binder | 2% | 1-5% | 0.5-10% |

To the example texture material described in Table A-2 is added propellant material in the form of DME. A first range of approximately 7-15% by weight of the propellant material is added to the example texture material of Table A-2, but the propellant material should in any event be within a second range of approximately 5-25% by weight of the propellant material.

TABLE A-3
(No Prime)

| | | First | Second | Third |
|---|---|---|---|---|
| Material | Purpose | Example | Example | Example |
| Water | Base | 42% | 40-50% | 30-60% |
| Pigment | Filler | 47% | 40-50% | 30-60% |
| Resin | Binder | 10% | 5-15% | 2.5-20% |

To the example texture material described in Table A-3 is added propellant material in the form of DME. A first range of approximately 10-15% by weight of the propellant material is added to the example texture material of Table A-3, but the propellant material should in any event be within a second range of approximately 5-25% by weight of the propellant material.

With reference to Tables A-4 and A-5 in Exhibit A, that table contains examples of a texture material composition adapted to be combined with an aerosol and dispensed using an aerosol dispensing system in accordance with the principles of the present invention. Each value or range of values in Tables A-4 and A-5 represents the percentage of the overall weight of the example texture material composition formed by each material of the texture material composition for a specific example, a first example range, and a second example range. The composition described in Table A-5 is similar to that of Table A-4, but Table A-5 contains a number of additional materials that may optionally be added to the example texture material composition of Table A-4.

One example of a method of combining the materials set forth in Table A-4 is as follows. Materials A, B, C, and D are combined to form a first sub-composition. The first sub-composition is mixed until material D is dissolved (e.g., 30-40 minutes). Materials E and F are then added to the first sub-composition to form a second sub-composition. The second sub-composition is mixed until materials E and F are well-dispersed (e.g., at high speed for 15-20 minutes). Material G is then added to the second sub-composition to form a third sub-composition. The third sub-composition is mixed well (e.g., 10 minutes). Typically, the speed at which the third sub-composition is mixed is reduced relative to the speed at which the second sub-composition is mixed. Next, materials H, I, and J are added to the third sub-composition to form the example texture material composition of the present invention. The example texture material composition is agitated. Material K may be added as necessary to adjust (e.g., reduce) the viscosity of the example texture material composition.

The example texture material composition of the present invention may be combined with an aerosol propellant in any of the aerosol dispensing systems described herein to facilitate application of the example texture material composition to a surface to be textured.

FIG. 1 further illustrates that the first example aerosol dispensing system 20a comprises a conduit 40a defining a conduit passageway 42a. The conduit 40a is supported by the container 30a such that the conduit passageway 42a defines a conduit inlet 44a arranged within the chamber 32a and a conduit outlet 46a arranged outside of the chamber 32a. The conduit outlet 46a may alternatively be referred to herein as an outlet opening 46a. The example conduit 40a is formed by an inlet tube 50a, a valve housing 52a, and an actuator structure 54a. The conduit passageway 42a extends through the inlet tube 50a, the valve housing 52a, and the actuator structure Ma such that the valve housing 52a is arranged between the conduit inlet 44a and the actuator structure 54a and the actuator structure 54a is arranged between the valve housing 52a and the conduit outlet 46a.

Arranged within the valve housing 52a is a valve system 60a. A first flow adjustment system 70a having a first adjustment member 72a is arranged to interface with the valve system 60a. A second flow adjustment system 80a having a second adjustment member 82a is arranged in the conduit passageway 42a to form at least a portion of the conduit outlet 46a.

The valve system 60a operates in a closed configuration, a fully open configuration, and at least one of a continuum or plurality of partially open intermediate configurations. In the closed configuration, the valve system 60a substantially prevents flow of fluid along the conduit passageway 42a. In the open configuration and the at least one intermediate configuration, the valve system 60a allows flow of fluid along the conduit passageway 42a. The valve system 60a is normally in the closed configuration. The valve system 60a engages the actuator member structure 54a and is placed into the open configuration by applying deliberate manual force on the actuator structure 54a towards the container 30a.

The first flow adjustment system 70a is supported by the container 30a to engage the actuator structure such that manual operation of the first adjustment member 72a affects operation of the valve system 60a to control the flow of fluid material along the conduit passageway 42a. In particular, the first adjustment system 70a and the valve system 60a function as a flow restrictor, where operation of the first adjustment member 72a results in a variation in the size of the conduit passageway 42a within the valve system 60a such that a pressure of the fluid material upstream of the first flow adjustment system 70a is relatively higher than the pressure of the fluid material downstream of the first flow adjustment system 70a.

In general, a primary purpose of the first flow adjustment system 70a is to alter a distance of travel of the dispensed material 22a. The first flow adjustment system 70a may also have a secondary affect on the pattern in which the dispensed material 22a is sprayed.

The second adjustment system 80a is supported by the actuator structure 54a downstream of the first adjustment system 70a. Manual operation of the second adjustment member 82a affects the flow of fluid material flowing out of the conduit passageway 42a through the conduit outlet 46a. In particular, the second adjustment system 80a functions as a variable orifice, where operation of the second adjustment member 82a variably reduces the size of the conduit outlet 46a relative to the size of the conduit passageway 42a upstream of the second adjustment system 80a.

A primary purpose of the second flow adjustment system 80a is to alter a pattern in which the dispensed material 22a is sprayed. The first flow adjustment system 70a may also have a secondary affect on the distance of travel of the dispensed material 22a.

To operate the first example aerosol dispensing system 20, the container 30a is grasped such that the finger can depress the actuator structure 54a. The conduit outlet or outlet opening 46a is initially aimed at a test surface and the actuator structure 54a is depressed to place the valve system 60a in the open configuration such that the pressurized material 36a forces some of the stored material 34a out of the container 30a and onto the test surface to form a test texture pattern. The test texture pattern is compared to the pre-existing texture pattern defined by the textured portion 26a of the target surface 24a. If the test texture pattern does not match the pre-existing texture pattern, one or both of the first and second adjustment systems 70a and 80a are adjusted to alter the spray pattern of the droplets of dispensed material 22a.

The process of spraying a test pattern and comparing it to the pre-existing pattern and adjusting the first and second adjustment members 72a and 82a is repeated until the dispensed material forms a desired texture pattern that substantially matches the pre-existing texture pattern.

Leaving the first and second adjustment systems 70a and 80a as they were when the test texture pattern matched the pre-existing texture pattern, the aerosol dispensing system 20a is then arranged such that the conduit outlet or outlet opening 46a is aimed at the un-textured portion 28a of the target surface 24a. The actuator structure 54a is again depressed to operate the valve system 60a such that the pressurized material 36a forces the stored material 34a out of the container 30a and onto the un-textured portion 28a of the target surface to form the desired texture pattern.

### A. Second Example Aerosol Dispensing System

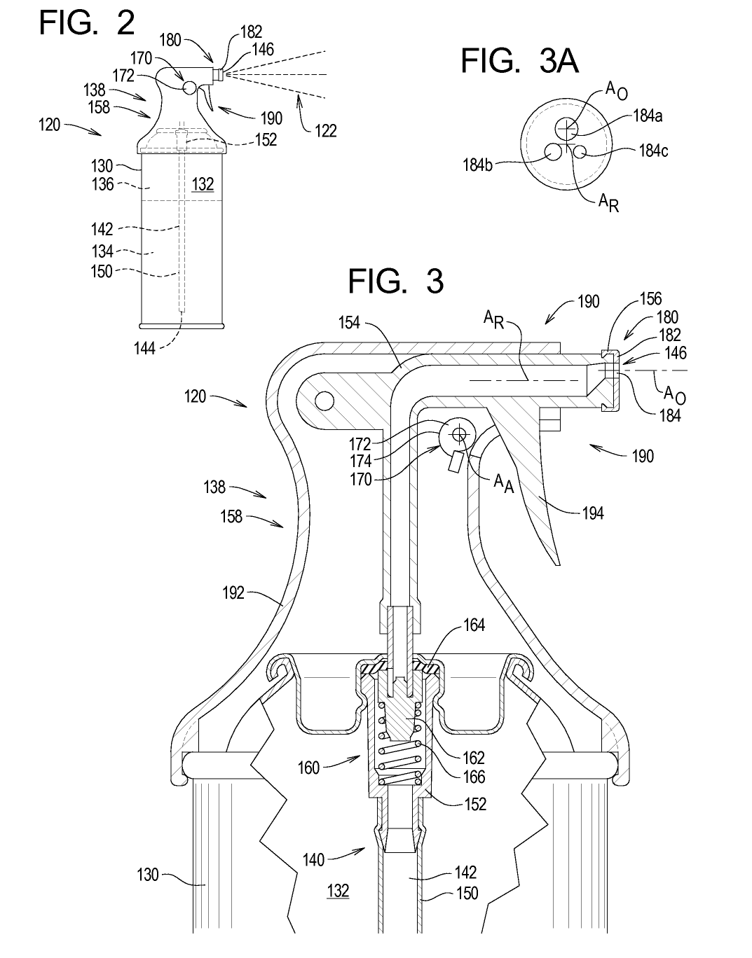

Referring now to FIGS. 2-5 of the drawing, depicted at 120 therein is a second example aerosol dispensing system constructed in accordance with, and embodying, the principles of the present invention. Like the first example aerosol dispensing system 20, the second example dispensing system 120 is adapted to spray droplets of dispensed material 122 onto a target surface (not shown). In the example use of the dispensing system 120 depicted in FIGS. 2-5, the dispensed material 122 is or contains texture material, and the dispensing system 120 is being used to form a coating on an un-textured portion of the target surface having a desired texture pattern that substantially matches a pre-existing texture pattern of a textured portion of the target surface.

FIG. 2 further illustrates that the example dispensing system 120 comprises a container 130 defining a chamber 132 in which stored material 134 and pressurized material 136 are contained. Like the stored material 34 described above, the stored material 134 is a mixture of texture material and propellant material in liquid phase, while the pressurized material is propellant material in gas phase. An actuator assembly 138 is mounted on the container assembly 130 to facilitate the dispensing of the dispensed material 122 as will be described in further detail below.

FIG. 3 illustrates that the second example aerosol dispensing system 120 comprises a conduit 140 defining a conduit passageway 142. The conduit 140 is supported by the container 130 such that the conduit passageway 142 defines a conduit inlet 144 arranged within the chamber 132 and a conduit outlet or outlet opening 146 arranged outside of the chamber 132. The example conduit 140 is formed by an inlet tube 150, a valve housing 152, and an actuator member 154. The conduit passageway 142 extends through the inlet tube 150, the valve housing 152, the actuator member 154, and the outlet member 156. The valve housing 152 is arranged between the conduit inlet 144 and the actuator member 154, and the actuator member 154 is arranged between the valve housing 152 and the conduit outlet 146. The outlet member 156 is supported by the actuator member 154 to define the conduit outlet 146. A grip assembly 158 is supported by the container assembly 130, and the grip assembly 158 in turn supports the actuator member 154 for movement relative to the container assembly 130.

Arranged within the valve housing 152 is a valve assembly 160. The example valve assembly 160 comprises a valve member 162, a valve seat 164, and a valve spring 166. The valve assembly 160 operates in a closed configuration and an open configuration. In the closed configuration, the valve spring 166 forces the valve member 162 against the valve seat 164 such that the valve assembly 160 substantially prevents flow of fluid along the conduit passageway 142. In the open configuration, the valve member 162 is displaced away from the valve seat 164 against the force of the valve spring 166 such that the valve assembly 160 allows flow of fluid along the conduit passageway 142 between the valve member 162 and the valve seat 164. Because the valve spring 166 biases the valve member 162 towards the valve seat 164, the example valve assembly 160 is normally closed. The valve assembly 160 engages the actuator member structure 154 such that the application of deliberate manual force on the actuator member 154 towards the container 130 moves the valve member 162 away from the valve seat 164 and thus places the valve system 160 in the open configuration.

A first flow adjustment system 170 comprising a first adjustment member 172 is arranged selectively to limit movement of the actuator member 154 relative to the container assembly 130. In particular, the first adjustment member defines an adjustment axis A_{A} and a stop surface 174. The stop surface 174 extends along a varying or substantially helical path relative to the adjustment axis A_{A}.

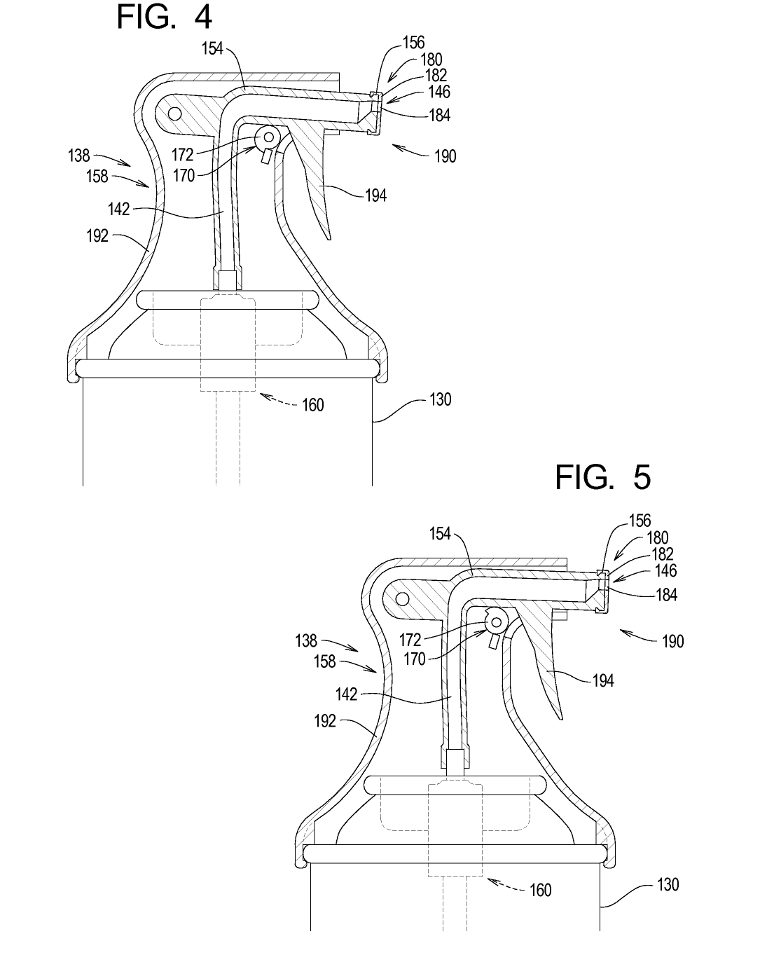

Rotation of the first adjustment member 172 relative to the grip assembly 158 thus alters a position of the stop surface 174 relative to the actuator member 154. With the first adjustment member 172 in a first angular position as shown in FIGS. 3 and 4, the actuator member 154 travels a first distance relative to the valve assembly 160. With the first adjustment member 172 in a second angular position as shown in FIG. 5, the actuator member 154 travels a second distance relative to the valve assembly 160. The first distance is longer than the first distance as can be seen by a close inspection of FIGS. 4 and 5, so the valve system 160, in cooperation with the first adjustment system 170, thus forms a bigger restriction in the conduit passageway 142 when the first adjustment member 172 is in the second angular position than when the first adjustment member 172 is in the first angular position.

Further, the first adjustment member 172 is configurable in any one of a plurality or continuum of angular positions between the first and second positions shown. The first adjustment system 170 thus allows the user to obtain a range of restrictions in the conduit passageway as necessary for a particular desired texture pattern.

A second flow adjustment system 180 having a second adjustment member 182 is arranged in the conduit passageway 142 to form at least a portion of the conduit outlet or outlet opening 146. In particular, the second adjustment member 182 defines a plurality of adjustment openings 184a, 184b, and 184c (FIG. 3A). The second adjustment member 182 is further rotatably supported by the actuator member 154 such that an axis of rotation A_{R} of the second adjustment member 182 is offset from an outlet axis A_{O} defined by the conduit outlet 146. Accordingly, rotating the second adjustment member 182 relative to the actuator member 154 allows any selected one of the outlet openings 184a, 184b, and 184c to be arranged to define a cross-sectional area of the outlet opening defined by the conduit outlet 146.

Manual operation of the first adjustment member 172 affects the flow of fluid material along the conduit passageway 142 upstream of the second adjustment system 180. In particular, the first adjustment system 170 functions as a flow restrictor, where operation of the first adjustment member 172 variably reduces the size of the conduit passageway 142 such that a pressure of the fluid material upstream of the first flow adjustment system 170 is relatively higher than the pressure of the fluid material downstream of the first flow adjustment system 170 (towards the second adjustment system 180).

The second adjustment system 180 is supported by the actuator member 154 downstream of the first adjustment system 170. The selected one of the adjustment openings 184a, 184b, and 184c thereby affects the flow of fluid material flowing out of the conduit passageway 142. The second adjustment system 180 thus functions as a variable orifice system. Operation of the second adjustment member 172 variably reduces the size of the conduit outlet or outlet opening 146 relative to the size of the conduit passageway 142 upstream of the second adjustment system 180.

The first adjustment member 172 and second adjustment member 182 are supported as described above to define a control system 190. FIG. 3 further shows that the grip assembly 158 comprises a grip housing 192 and that the actuator member 154 defines a trigger portion 194. Additionally, the grip assembly 158 is combined with the control system 190 to form the actuator assembly 138, and the actuator assembly 138 is supported by the container assembly 130 as generally described above. In the example actuator assembly 138, the actuator assembly 138 is pivotably connected to the grip housing 192. Accordingly, to operate the second example aerosol dispensing system 120, the container 130 and grip housing 192 are grasped such that the user's fingers can squeeze the trigger portion 194, thereby allowing the actuator member 154 to be depressed.

In use, the conduit outlet or outlet opening 146 is initially aimed at a test surface and the actuator member 154 is depressed to place the valve assembly 160 in the open configuration such that the pressurized material 136 forces some of the stored material 134 out of the container 130 and onto the test surface to form a test texture pattern. The test texture pattern is compared to the pre-existing texture pattern defined by the textured portion of the target surface. If the test texture pattern does not match the pre-existing texture pattern, one or both of the first and second adjustment members is/are adjusted to alter the spray pattern of the droplets of dispensed material 122.

The process of spraying a test pattern and adjusting the first and second adjustment members 172 and 182 is repeated until the test pattern formed by the dispensed material 122 corresponds to a desired texture pattern that substantially matches the pre-existing texture pattern.

Leaving the first and second adjustment members 172 and 182 as they were when the test texture pattern corresponded to the desired texture pattern, the aerosol dispensing system 120 is then arranged such that the conduit outlet or outlet opening 146 is aimed at the un-textured portion of the target surface. The trigger member 194 is again squeezed to place the valve assembly 160 in the open configuration such that the pressurized material 136 forces the stored material 134 out of the container 130 and onto the un-textured portion of the target surface to form the desired texture pattern on the un-textured portion of the target surface, perhaps overlapping slightly with the textured portion of the target surface. Since the desired texture pattern substantially matches the pre-existing texture pattern, the dispensed material forms a coating on the previously un-textured portion of the target surface in a desired texture pattern that substantially matches a physical appearance of the textured portion. One or more layers of primer and/or paint may next be applied over the cured layer of dispensed material on the target surface.

The following Table B represents example ranges and dimensions for constructing a physical embodiment of a flow adjustment system that may be used as the example first flow adjustment system 170:

TABLE B

| Config. | Units | Example | First Range | Second Range |
|---|---|---|---|---|
| First Angular | % Passageway | 100 | 95-100 | 90-100 |
| Position | Square Inches | .00385 | 0.00424- | 0.00578- |
| | | | 0.00347 | 0.00193 |
| Second | % Passageway | 12 | 8-16 | 5-20 |
| Angular | Square Inches | .00045 | 0.00050- | 0.00068- |
| Position | | | 0.00041 | 0.00023 |

### B. Third Example Aerosol Dispensing System

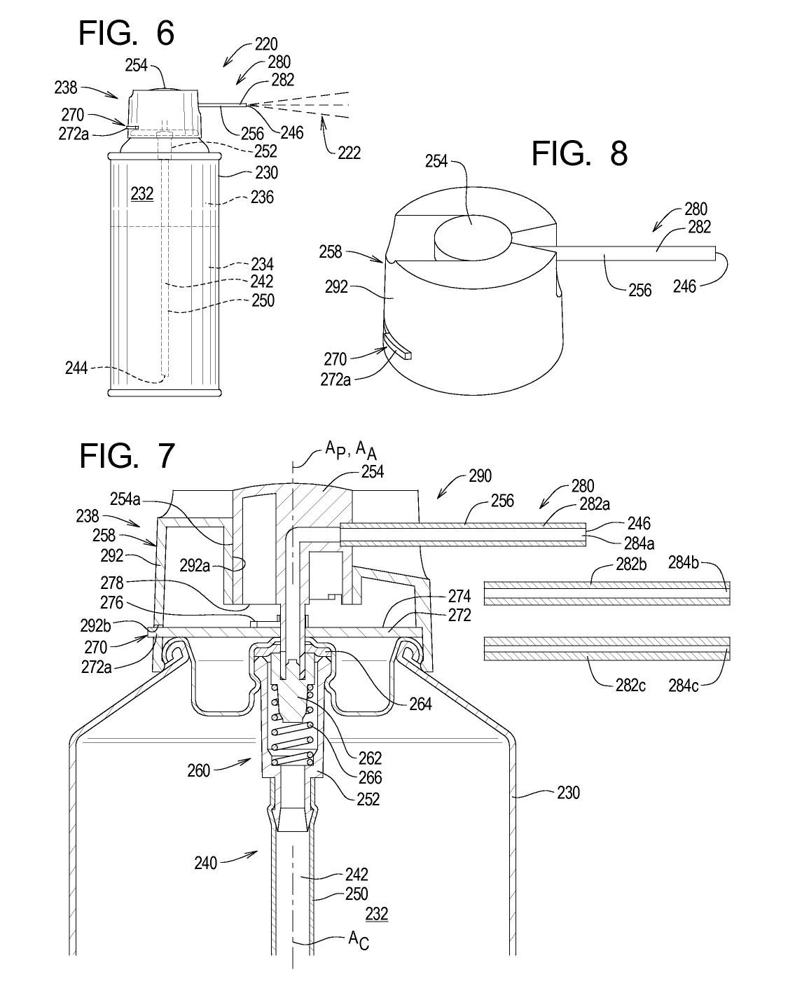

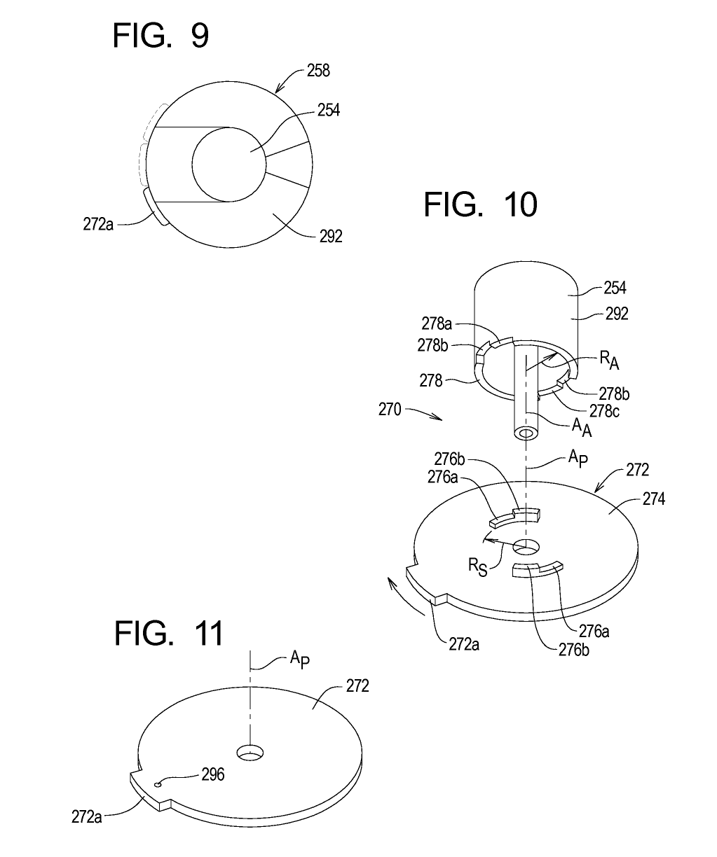

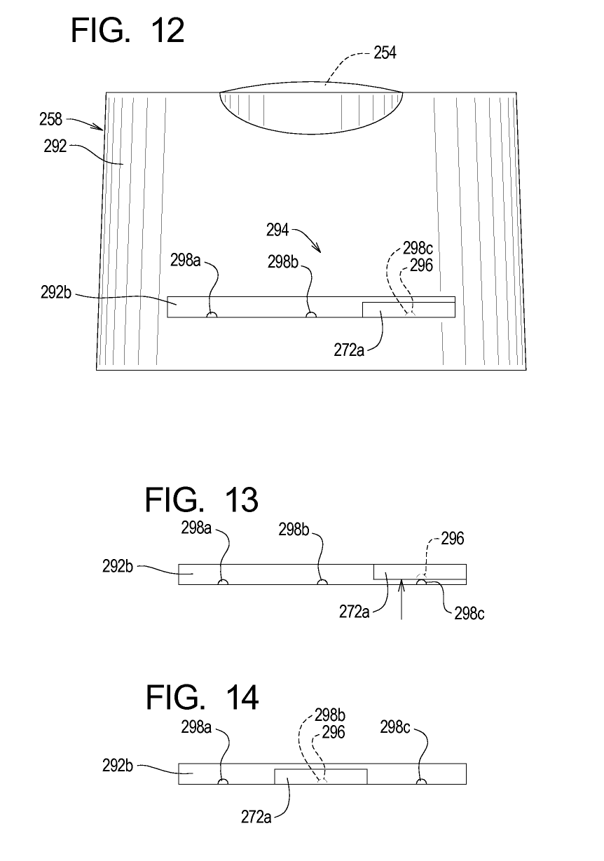

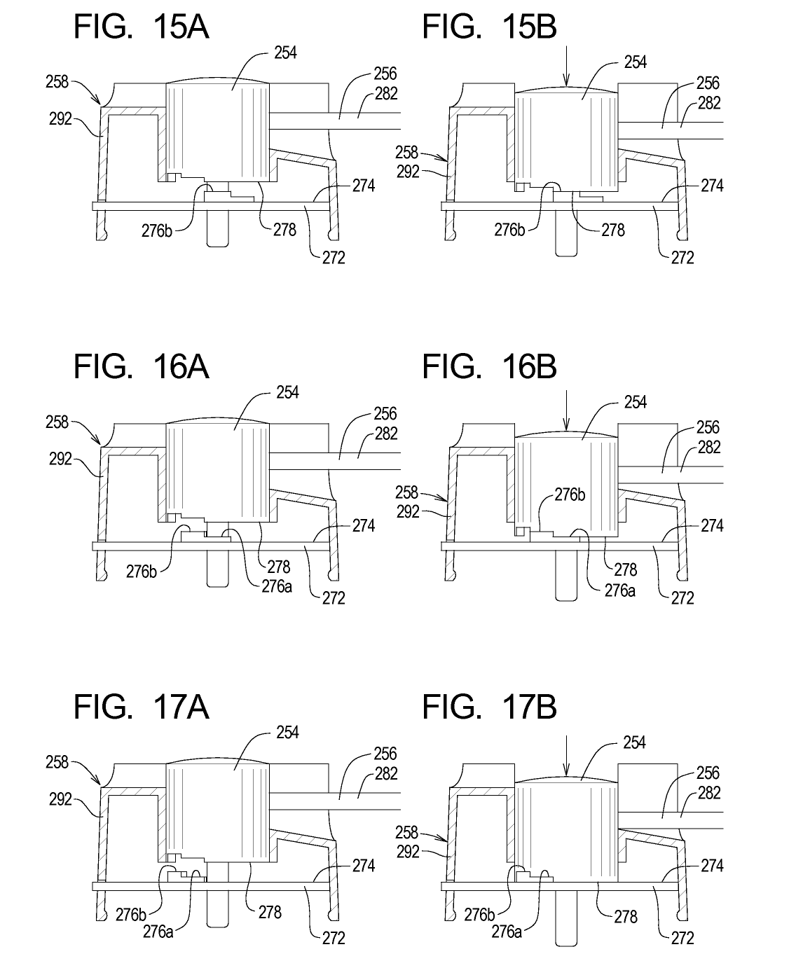

Referring now to FIGS. 6-17 of the drawing, depicted at 220 therein is a third example aerosol dispensing system constructed in accordance with, and embodying, the principles of the present invention. Like the first example aerosol dispensing system 20, the third example dispensing system 220 is adapted to spray droplets of dispensed material 222 onto a target surface (not shown). In the example use of the dispensing system 220 depicted in FIGS. 6-17, the dispensed material 222 is or contains texture material, and the dispensing system 220 is being used to form a coating on an un-textured portion of the target surface having a desired texture pattern that substantially matches a pre-existing texture pattern of a textured portion of the target surface.

FIG. 6 further illustrates that the example dispensing system 220 comprises a container 230 defining a chamber 232 in which stored material 234 and pressurized material 236 are contained. Like the stored material 34 described above, the stored material 234 is a mixture of texture material and propellant material in liquid phase, while the pressurized material is propellant material in gas phase. An actuator assembly 238 is mounted on the container assembly 230 to facilitate the dispensing of the dispensed material 222 as will be described in further detail below.

FIG. 7 illustrates that the second example aerosol dispensing system 220 comprises a conduit 240 defining a conduit passageway 242. The conduit 240 is supported by the container 230 such that the conduit passageway 242 defines a conduit inlet 244 arranged within the chamber 232 and a conduit outlet or outlet opening 246 arranged outside of the chamber 232. The example conduit 240 is formed by an inlet tube 250, a valve housing 252, and an actuator member 254. The conduit passageway 242 extends through the inlet tube 250, the valve housing 252, the actuator member 254, and the outlet member 256. The valve housing 252 is arranged between the conduit inlet 244 and the actuator member 254, and the actuator member 254 is arranged between the valve housing 252 and the conduit outlet 246. The outlet member 256 is supported by the actuator member 254 to define the conduit outlet 246. A grip assembly 258 is supported by the container assembly 230, and the grip assembly 258 in turn supports the actuator member 254 for movement relative to the container assembly 230.

Arranged within the valve housing 252 is a valve assembly 260. The example valve assembly 260 comprises a valve member 262, a valve seat 264, and a valve spring 266. The valve assembly 260 operates in a closed configuration and an open configuration. In the closed configuration, the valve spring 266 forces the valve member 262 against the valve seat 264 such that the valve assembly 260 substantially prevents flow of fluid along the conduit passageway 242. In the open configuration, the valve member 262 is displaced away from the valve seat 264 against the force of the valve spring 266 such that the valve assembly 260 allows flow of fluid along the conduit passageway 242 between the valve member 262 and the valve seat 264. Because the valve spring 266 biases the valve member 262 towards the valve seat 264, the example valve assembly 260 is normally closed. The valve assembly 260 engages the actuator member structure 254 such that the application of deliberate manual force on the actuator member 254 towards the container 230 moves the valve member 262 away from the valve seat 264 and thus places the valve system 260 in the open configuration.

A first flow adjustment system 270 comprising a first adjustment member 272 is arranged selectively to limit movement of the actuator member 254 relative to the container assembly 230. In particular, the first adjustment member 272 is a plate or disc defining an upper surface 274 and a plate axis Aₚ, and, optionally, comprises at least one stop surface 276. The at least one example stop surface 276 is arranged in an arcuate segment on the upper surface 274 and define a stop radius R_{S} relative to the plate axis A. In the example first adjustment member 272, two pairs of stop surfaces 276a and 276b are formed in opposing locations relative to the plate axis A.

The example flow adjustment system 270 further comprises at least one engaging surface 278 formed on the actuator member 254. The example actuator member 254 defines an actuator axis A_{A}, and the at least one engaging surface 278 is arranged in an arcuate segment on the lower edge of the actuator member 254 and defines an actuator radius R_{A} relative to the actuator axis A_{A}. The actuator radius R_{A} and the stop radius R_{S} are substantially the same in the example flow adjustment system 270.

In general, the actuator member 254 is arranged relative to the first adjustment member 272 such that rotation of the first adjustment member 272 relative to the grip assembly 258 alters an angular position of the at least one stop surface 276 relative to the at least one engaging surface 278 of actuator member 254. The angular relationship of the at least one stop surface 274 relative to the at least one engaging surface 278 determines an amount of travel of the actuator member 254 relative to the container assembly 230 and the valve system 260 supported thereby.

In particular, with the first adjustment member 272 in a first angular position relative to the actuator member 254 as shown in FIGS. 15A and 15B, the actuator member 254 travels a first distance relative to the valve assembly 260. With the first adjustment member 272 in a second angular position as shown in FIGS. 16A and 16B, the actuator member 254 travels a second distance relative to the valve assembly 260. With the first adjustment member 272 in a third angular position as shown in FIGS. 17A and 17B, the actuator member 254 travels a second distance relative to the valve assembly 260. The third distance is longer than the second distance and the second distance is longer than the first distance, as can be seen by a close inspection of FIGS. 15B, 16B, and 17B. Travel of the actuator member 254 determines the size of the opening defined by the valve system 260. The example valve system 260, in cooperation with the first adjustment system 270, thus allows the size of the restriction in the conduit passageway 242 formed by the valve system to be varied depending upon the angular position of the first adjustment member 272.

Further, the first adjustment member 272 may configurable in any one of a plurality or continuum of angular positions by using slanted stop and engaging surfaces rather than the arrangement of stop surfaces 276 and engaging surfaces 278 of the example first adjustment system 260. The first adjustment system 270 thus allows the user to obtain a range of restrictions in the conduit passageway as necessary for a particular desired texture pattern.

A second flow adjustment system 280 having a second adjustment member 282 is arranged in the conduit passageway 242 to form at least a portion of the conduit outlet or outlet opening 246. In particular, the second adjustment member 282 of the example second flow adjustment system 280 takes the form of at least one adjustment straw or tube (FIG. 7). Each second adjustment member 282 defines an outlet orifice 284. The example second flow adjustment system 280 comprises three second adjustment members 282a, 282b, and 282c defining outlet orifices 284a, 284b, and 284c, respectively. Each of the outlet orifices 284a, 284b, and 284c defines a different cross-sectional area.

A selected one of the second adjustment members 282a, 282b, and 284c is detachably attached to the actuator member 254 such that the outlet orifice 284a, 284b, or 284c associated with the selected second adjustment member 282a, 282b, or 282c is aligned with the conduit outlet 246. Accordingly, any selected one of the outlet orifices 284a, 284b, and 284c may be selected and arranged to define a cross-sectional area of the outlet opening defined by the conduit outlet 246.

Manual operation of the first adjustment member 272 affects the flow of fluid material along the conduit passageway 242 upstream of the second adjustment system 280. In particular, the first adjustment system 270 functions as a flow restrictor, where operation of the first adjustment member 272 variably reduces the size of the conduit passageway 242 such that a pressure of the fluid material upstream of the first flow adjustment system 270 is relatively higher than the pressure of the fluid material downstream of the first flow adjustment system 270 (towards the second adjustment system 280).

The second adjustment system 280 is supported by the actuator member 254 downstream of the first adjustment system 270. The selected one of the outlet orifices 284a, 284b, and 284c thereby affects the flow of fluid material flowing out of the conduit passageway 242. The second adjustment system 280 thus functions as a variable orifice system. Operation of the second adjustment member 272 variably reduces the size of the conduit outlet or outlet opening 246 relative to the size of the conduit passageway 242 upstream of the second adjustment system 280.

The actuator member 254, the first adjustment member 272, and the selected one of the second adjustment members 282 supported to define a control system 290. FIG. 7 further shows that the grip assembly 258 comprises a grip housing 292. Additionally, the grip assembly 258 is combined with the control system 290 to form the actuator assembly 238, and the actuator assembly 238 is supported by the container assembly 230 as generally described above.

In the example actuator assembly 238, grip housing 292 defines a cylindrical interior surface 292a and the actuator member 254 defines a cylindrical outer surface 254a. The outer surface 254a is sized and dimensioned to allow the actuator member 254 to fit within a grip chamber defined by the interior surface 292a such that the grip housing 292 supports the actuator member 254 for substantially linear movement along a container axis A_{C} defined by the container assembly 230.

Accordingly, to operate the second example aerosol dispensing system 220, the container 230 and grip housing 292 are grasped such that the user's fingers can depress an upper surface of the actuator member 254, thereby allowing the actuator member 254 to be depressed.

Further, FIGS. 11-14 illustrate a locator system 294 that may be used to locate the first adjustment member 272 in the plurality of angular positions represented by FIGS. 15A and 15B, 16A and 16B, and 17A and 17B. In particular, the example lock system 294 comprises at least one locator recess 296 formed on the first adjustment member 172 and at least one locator projection 298 formed on the grip housing 292. In particular, the grip housing 292 defines a housing slot 292b through which a grip portion 272a of the first adjustment member 272 extends. By pushing on the grip portion 272a, the first adjustment member 272 may be rotated through the plurality of angular positions. The locator recess(es) 296 receives a locator projection 298 to positively hold the first adjustment member 272 in one of the plurality of angular positions. The shapes, locations, and relative positions of the locator recess(es) 296 and the locator projection(s) 298 may be altered. One locator recess 296 and three locator projections 298a, 298b, and 298c are employed by the example locator system 294.

In use, the conduit outlet or outlet opening 246 is initially aimed at a test surface and the actuator member 254 is depressed to place the valve assembly 260 in the open configuration to allow the pressurized material 236 to force some of the stored material 234 out of the container 230 and onto the test surface to form a test texture pattern. The test texture pattern is compared to the pre-existing texture pattern defined by the textured portion of the target surface. If the test texture pattern does not match the pre-existing texture pattern, one or both of the first and second adjustment members is/are adjusted to alter the spray pattern of the droplets of dispensed material 222.

The process of spraying a test pattern and adjusting the first and second adjustment members 272 and 282 is repeated until the test pattern formed by the dispensed material 222 corresponds to a desired texture pattern that substantially matches the pre-existing texture pattern.

Leaving the first and second adjustment members 272 and 282 as they were when the test texture pattern corresponded to the desired texture pattern, the aerosol dispensing system 220 is then arranged such that the conduit outlet or outlet opening 246 is aimed at the un-textured portion of the target surface. The actuator member 254 is again depressed to place the valve assembly 260 in the open configuration such that the pressurized material 236 forces the stored material 234 out of the container 230 and onto the un-textured portion of the target surface to form the desired texture pattern on the un-textured portion of the target surface, perhaps overlapping slightly with the textured portion of the target surface. Since the desired texture pattern substantially matches the pre-existing texture pattern, the dispensed material forms a coating on the previously un-textured portion of the target surface in a desired texture pattern that substantially matches a physical appearance of the textured portion. One or more layers of primer and/or paint may next be applied over the cured layer of dispensed material on the target surface.

The following Table C represents example ranges and dimensions for constructing a physical embodiment of a flow adjustment system that may be used as the example first flow adjustment system 270:

TABLE C

| Config. | Units | Example | First Range | Second Range |
|---|---|---|---|---|
| First | % Passageway | 100 | 95-100 | 90-100 |
| Angular | Square Inches | .00385 | 0.00424- | 0.00578- |
| Position | | | 0.00347 | 0.00193 |
| Second | % Passageway | 60 | 55-65 | 40-70 |
| Angular | Square Inches | .00230 | 0.00253- | 0.00345- |
| Position. | | | 0.00207 | 0.00115 |
| Third | % Passageway | 12 | 8-16 | 5-20 |
| Angular | Square Inches | .00045 | 0.00050- | 0.00068- |
| Position | | | 0.00041 | 0.00023 |

### C. Fourth Example Aerosol Dispensing System

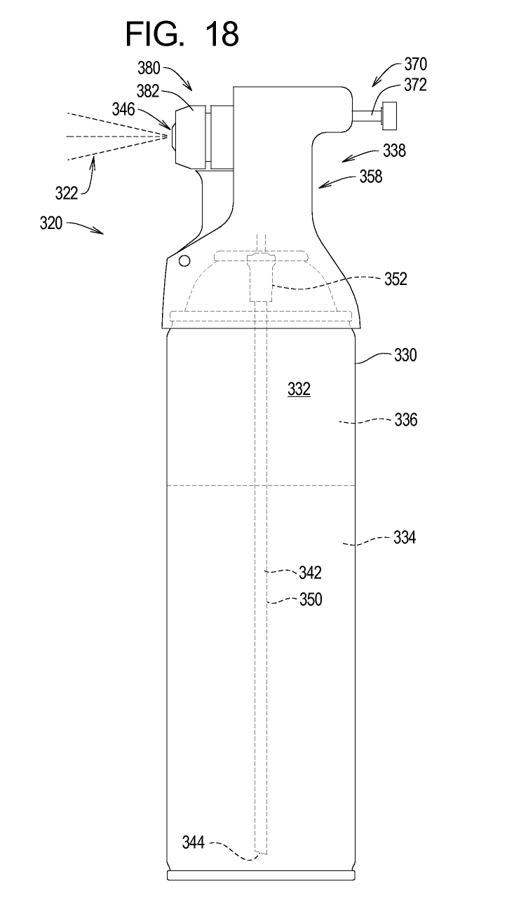

Referring now to FIGS. 18-22 of the drawing, depicted at 320 therein is a fourth example aerosol dispensing system constructed in accordance with, and embodying, the principles of the present invention. Like the first example aerosol dispensing system 20, the fourth example dispensing system 320 is adapted to spray droplets of dispensed material 322 onto a target surface (not shown). In the example use of the dispensing system 320 depicted in FIGS. 18-22, the dispensed material 322 is or contains texture material, and the dispensing system 320 is being used to form a coating on an un-textured portion of the target surface having a desired texture pattern that substantially matches a pre-existing texture pattern of a textured portion of the target surface.

FIG. 18 illustrates that the example dispensing system 320 comprises a container 330 defining a chamber 332 in which stored material 334 and pressurized material 336 are contained. Like the stored material 34 described above, the stored material 334 is a mixture of texture material and propellant material in liquid phase, while the pressurized material is propellant material in gas phase. An actuator assembly 338 is mounted on the container assembly 330 to facilitate the dispensing of the dispensed material 322 as will be described in further detail below.

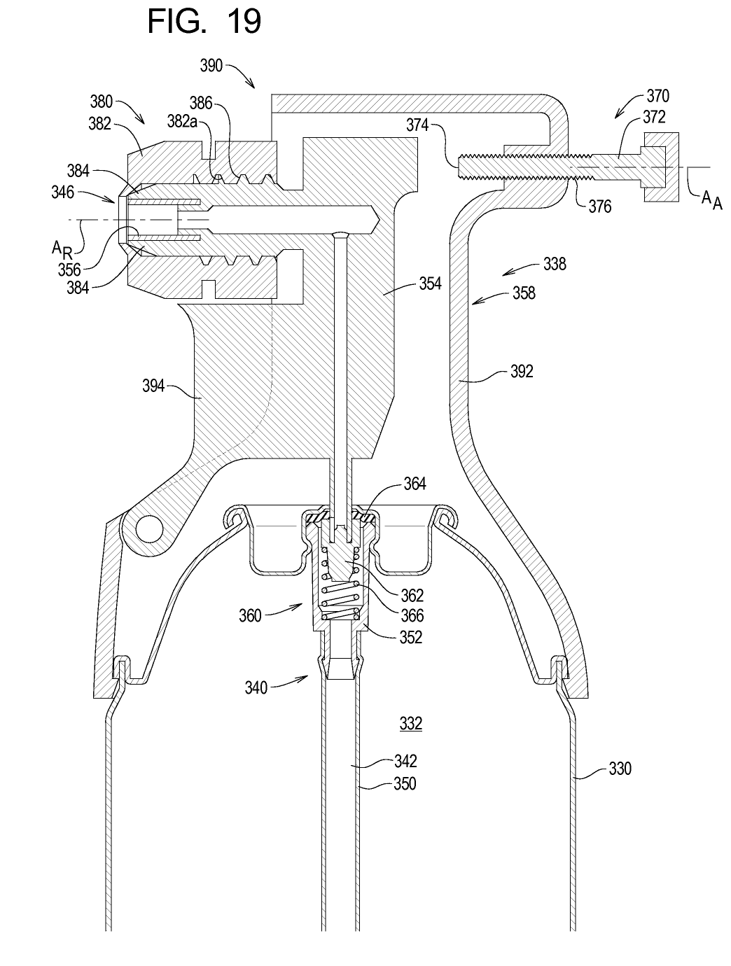

FIG. 19 illustrates that the second example aerosol dispensing system 320 comprises a conduit 340 defining a conduit passageway 342. The conduit 340 is supported by the container 330 such that the conduit passageway 342 defines a conduit inlet 344 arranged within the chamber 332 and a conduit outlet or outlet opening 346 arranged outside of the chamber 332. The example conduit 340 is formed by an inlet tube 350, a valve housing 352, an actuator member 354, and an outlet member 356. The conduit passageway 342 extends through the inlet tube 350, the valve housing 352, the actuator member 354, and the outlet member 356. The valve housing 352 is arranged between the conduit inlet 344 and the actuator member 354, and the actuator member 354 is arranged between the valve housing 352 and the conduit outlet 346. The outlet member 356 is supported by the actuator member 354 to define the conduit outlet 346. A grip assembly 358 is supported by the container assembly 330, and the grip assembly 358 in turn supports the actuator member 354 for movement relative to the container assembly 330.

Arranged within the valve housing 352 is a valve assembly 360. The example valve assembly 360 comprises a valve member 362, a valve seat 364, and a valve spring 366. The valve assembly 360 operates in a closed configuration and an open configuration. In the closed configuration, the valve spring 366 forces the valve member 362 against the valve seat 364 such that the valve assembly 360 substantially prevents flow of fluid along the conduit passageway 342. In the open configuration, the valve member 362 is displaced away from the valve seat 364 against the force of the valve spring 366 such that the valve assembly 360 allows flow of fluid along the conduit passageway 342 between the valve member 362 and the valve seat 364. Because the valve spring 366 biases the valve member 362 towards the valve seat 364, the example valve assembly 360 is normally closed. The valve assembly 360 engages the actuator member structure 354 such that the application of deliberate manual force on the actuator member 354 towards the container 330 moves the valve member 362 away from the valve seat 364 and thus places the valve system 360 in the open configuration.

A first flow adjustment system 370 comprising a first adjustment member 372 is arranged selectively to limit movement of the actuator member 354 relative to the container assembly 330. In particular, the first adjustment member defines an adjustment axis A_{A} and a stop surface 374.

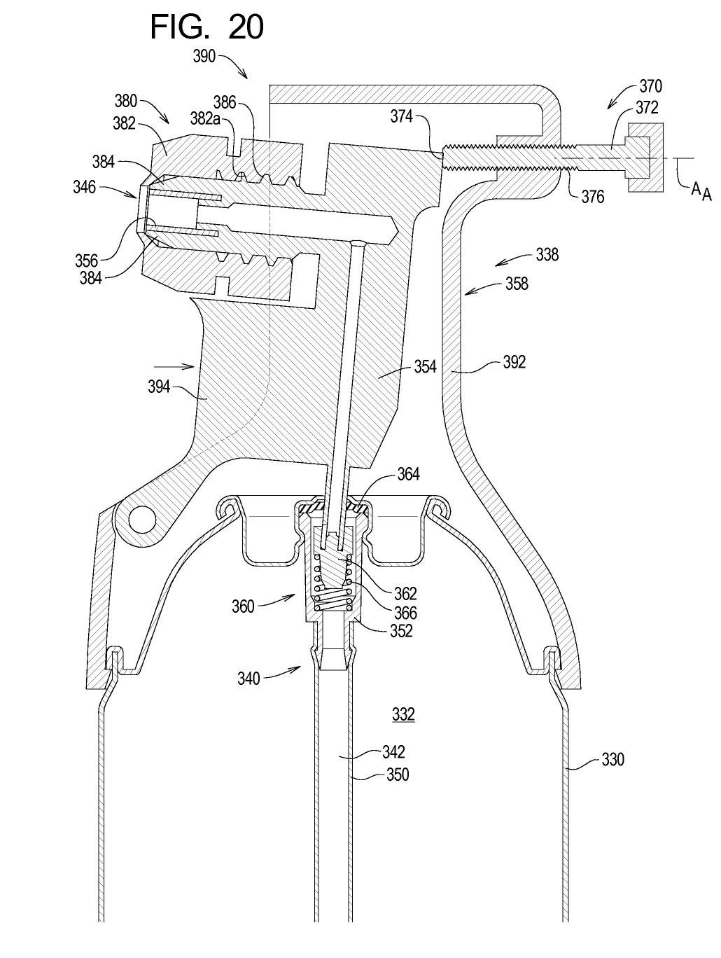

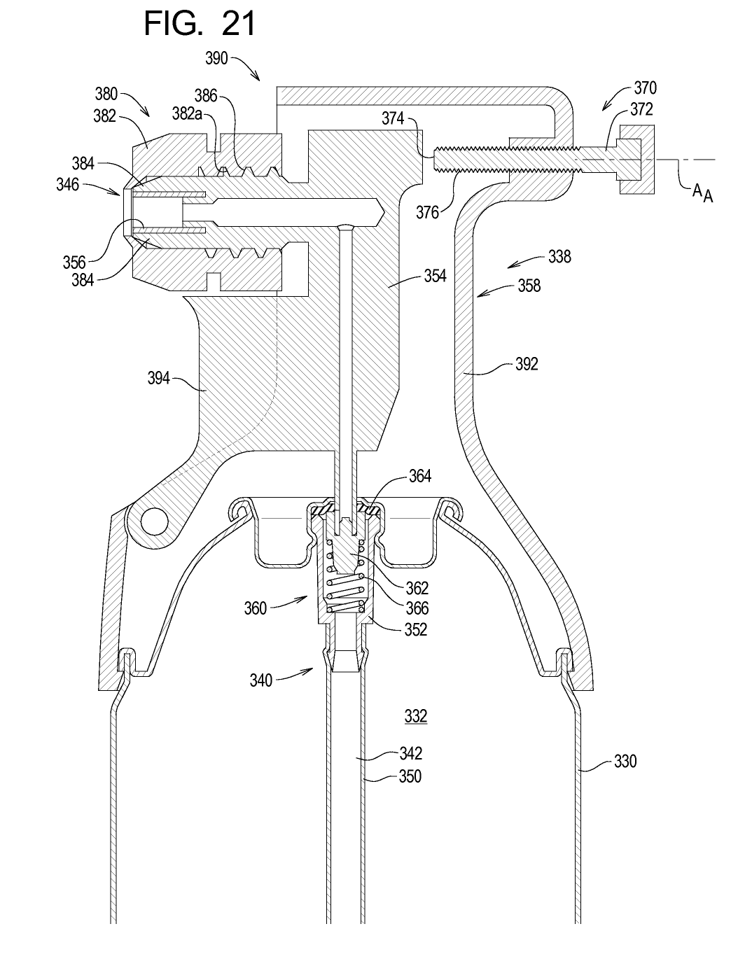

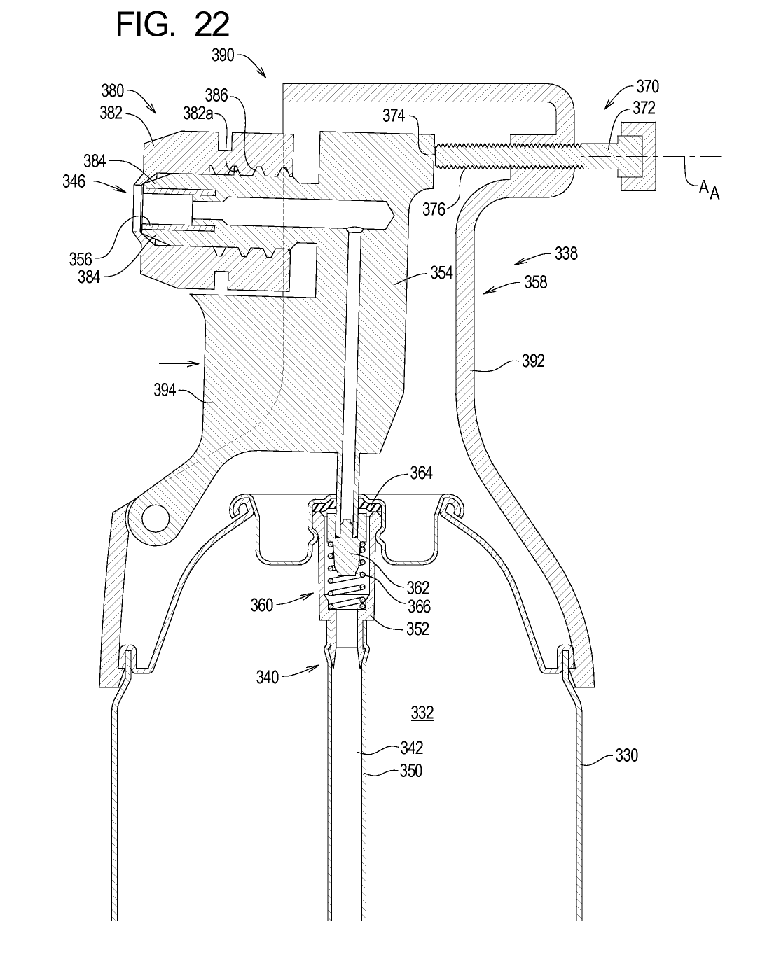

Rotation of the first adjustment member 372 about the adjustment axis A_{A} relative to the grip assembly 358 thus alters a position of the stop surface 374 relative to the actuator member 354. In particular, the first adjustment member 372 defines an externally threaded surface 376 adapted to engage a similar internally threaded surface defined by the grip assembly 358. Rotating the first adjustment member 372 displaces the first adjustment member 372 towards and away from the actuator member 354 between a fully open position and a terminal position. In a first position as shown in FIGS. 19 and 20, the actuator member 354 travels a first distance relative to the valve assembly 360. With the first adjustment member 372 in a second position as shown in FIGS. 21 and 22, the actuator member 354 travels a second distance relative to the valve assembly 360. The first distance is longer than the second distance as can be seen by a close inspection of FIGS. 20 and 22, so the valve system 360, in cooperation with the first adjustment system 370, thus forms a smaller restriction in the conduit passageway 342 when the first adjustment member 372 is in the first position than when the first adjustment member 372 is in the second position.

Further, the first adjustment member 372 is configurable in any one of a plurality or continuum of positions between the first and second positions shown. The first adjustment system 370 thus allows the user to obtain a range of restrictions in the conduit passageway as necessary for a particular desired texture pattern.

A second flow adjustment system 380 having a second adjustment member 382 is arranged in the conduit passageway 342 to form at least a portion of the conduit outlet or outlet opening 346. In particular, the second adjustment system 380 comprises, in addition, a plurality of fingers 384 extending from the actuator member 354 and an externally threaded surface 386 formed on the actuator member 354. The second adjustment member 382 defines an internally threaded surface 382a that is adapted to engage the externally threaded surface 386 such that rotation of the second adjustment member 382 about an axis of rotation A_{R} displaces the adjustment member in both directions along the axis of rotation A_{R}. As the second adjustment member 382 is displaced along the axis of rotation A_{R}, the second adjustment member 382 engages the fingers 284 to deform the outlet member 356. Deformation of the outlet member 356 alters a cross-sectional area of the conduit outlet or outlet opening 346. Accordingly, rotation of the second adjustment member 382 relative to the actuator member 354 allows any the cross-sectional area of the outlet opening defined by the conduit outlet 346 to be made larger and/or smaller within a predetermined range of cross-sectional areas.

Manual operation of the first adjustment member 372 affects the flow of fluid material along the conduit passageway 342 upstream of the second adjustment system 380. In particular, the first adjustment system 370 functions as a flow restrictor, where operation of the first adjustment member 372 variably reduces the size of the conduit passageway 342 such that a pressure of the fluid material upstream of the first flow adjustment system 370 is relatively higher than the pressure of the fluid material downstream of the first flow adjustment system 370 (towards the second adjustment system 380).

The second adjustment system 380 is supported by the actuator member 354 downstream of the first adjustment system 370. Adjustment of the first adjustment system 370 (e.g., selecting one of the adjustment openings 384a, 384b, and 384c) thereby affects the flow of fluid material flowing out of the conduit passageway 342. The second adjustment system 380 thus functions as a variable orifice system. Operation of the second adjustment member 372 variably reduces the size of the conduit outlet or outlet opening 346 relative to the size of the conduit passageway 342 upstream of the second adjustment system 380.

The first adjustment member 372 and second adjustment member 382 are supported as described above to define a control system 390. FIG. 19 further shows that the grip assembly 358 comprises a grip housing 392 and that the actuator member 354 defines a trigger portion 394. Additionally, the grip assembly 358 is combined with the control system 390 to form the actuator assembly 338, and the actuator assembly 338 is supported by the container assembly 330 as generally described above. In the example actuator assembly 338, the actuator assembly 338 is pivotably connected to the grip housing 392. Accordingly, to operate the second example aerosol dispensing system 320, the container 330 and grip housing 392 are grasped such that the user's fingers can squeeze the trigger portion 394, thereby allowing the actuator member 354 to be depressed.

In use, the conduit outlet or outlet opening 346 is initially aimed at a test surface and the actuator member 354 is depressed to place the valve assembly 360 in the open configuration such that the pressurized material 336 forces some of the stored material 334 out of the container 330 and onto the test surface to form a test texture pattern. The test texture pattern is compared to the pre-existing texture pattern defined by the textured portion of the target surface. If the test texture pattern does not match the pre-existing texture pattern, one or both of the first and second adjustment members is/are adjusted to alter the spray pattern of the droplets of dispensed material 322.

The process of spraying a test pattern and adjusting the first and second adjustment members 372 and 382 is repeated until the test pattern formed by the dispensed material 322 corresponds to a desired texture pattern that substantially matches the pre-existing texture pattern.

Leaving the first and second adjustment members 372 and 382 as they were when the test texture pattern corresponded to the desired texture pattern, the aerosol dispensing system 320 is then arranged such that the conduit outlet or outlet opening 346 is aimed at the un-textured portion of the target surface. The trigger member 394 is again squeezed to place the valve assembly 360 in the open configuration such that the pressurized material 336 forces the stored material 334 out of the container 330 and onto the un-textured portion of the target surface to form the desired texture pattern on the un-textured portion of the target surface, perhaps overlapping slightly with the textured portion of the target surface. Since the desired texture pattern substantially matches the pre-existing texture pattern, the dispensed material forms a coating on the previously un-textured portion of the target surface in a desired texture pattern that substantially matches a physical appearance of the textured portion. One or more layers of primer and/or paint may next be applied over the cured layer of dispensed material on the target surface.

The following Table D represents example ranges and dimensions for constructing a physical embodiment of a flow adjustment system that may be used as the example first flow adjustment system 370:

TABLE D

| Config. | Units | Example | First Range | Second Range |
|---|---|---|---|---|
| Fully Open | % Passageway | 100 | 95-100 | 90-100 |
| Position | Square Inches | .00385 | 0.00424- | 0.00578- |
| | | | 0.00347 | 0.00193 |
| Terminal | % Passageway | 12 | 8-16 | 5-20 |
| Position | Square Inches | .00045 | 0.00050- | 0.00068- |
| | | | 0.00041 | 0.00023 |

### II. Second Example Class of Aerosol Dispensing Systems

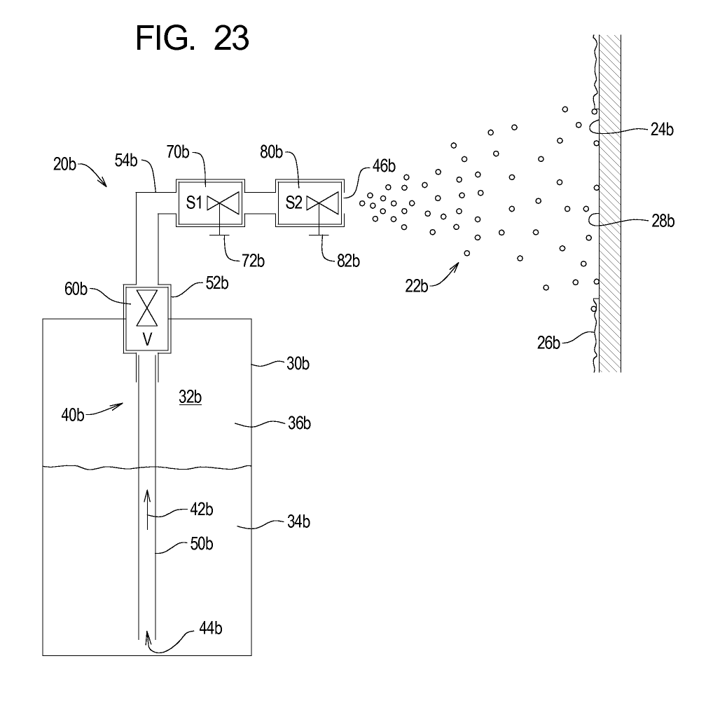

Referring now to FIG. 23 of the drawing, depicted at 20b therein is a fifth example aerosol dispensing system constructed in accordance with, and embodying, the principles of the present invention. The fifth example dispensing system is adapted to spray droplets of dispensed material 22b onto a target surface 24b. The example target surface 24b has a textured portion 26b and an un-textured portion 28b. Accordingly, in the example use of the dispensing system 20b depicted in FIG. 23, the dispensed material 22b is or contains texture material, and the dispensing system 20b is being used to form a coating on the un-textured portion 28b having a desired texture pattern that substantially matches a pre-existing texture pattern of the textured portion 26b.

FIG. 23 further illustrates that the example dispensing system 20b comprises a container 30b defining a chamber 32b in which stored material 34b and pressurized material 36b are contained. The stored material 34b is a mixture of texture material and propellant material in liquid phase, while the pressurized material is propellant material in gas phase.

A typical texture material forming a part of the dispensed material 22b and/or stored material 34b will comprise a base or carrier, a binder, a filler, and, optionally, one or more additives such as surfactants, biocides and thickeners. Examples of the base or carrier include water, solvent (oil-based texture material) such as xylene, toluene, acetone, methyl ethyl ketone, and combinations of water and water soluble solvents. Examples of binders include starch, polyvinyl alcohol and latex resins (water-based systems) and a wide variety of polymers such as ethylene vinyl acetate, thermoplastic acrylics, styrenated alkyds, etc. (solvent-based systems.). Examples of fillers include calcium carbonate, titanium dioxide, attapulgite clay, talc, magnesium aluminum silicate, etc.

The stored material 34b will also comprise a liquid phase propellant material, and the pressurized material will typically comprise a gas phase propellant material. The following propellant materials are appropriate for use as the propellant material forming the stored material 34b and the pressurized material 36b: dimethyl ether, propane, butane, isobutene, difluoroethane, and tetrafluoroethane.

The following Tables E-1, E-2, and E-3 contain example formulations of the texture material that may be used to form the dispensed material 22b and stored material 34b of the second example aerosol dispensing 20b:

TABLE E-1
(Solvent Based)

| | | First | Second | Third |
|---|---|---|---|---|
| Material | Purpose | Example | Example | Example |
| Solvent | Base | 35% | 30-40% | 20-60% |
| Pigment | Filler | 60% | 55-65% | 40-80% |
| Resin | Binder | 2.5% | 1-5% | 0.5-15% |

To the example texture material described in Table E-1 is added 10-20% by weight of propellant material in the form of a propane/butane/isobutane blend.

TABLE E-2
(Knockdown)

| | | First | Second | Third |
|---|---|---|---|---|
| Material | Purpose | Example | Example | Example |
| Water | Base | 48% | 45-55% | 40-60% |
| Pigment | Filler | 50% | 45-55% | 40-60% |
| Resin | Binder | 2% | 1-5% | 0.5-10% |

To the example texture material described in Table E-2 is added 7-15% by weight of propellant material in the form of DME.

TABLE E-3
(No Prime)

| | | First | Second | Third |
|---|---|---|---|---|
| Material | Purpose | Example | Example | Example |
| Water | Base | 42% | 40-50% | 30-60% |
| Pigment | Filler | 47% | 40-50% | 30-60% |
| Resin | Binder | 10% | 5-15% | 2.5-20% |

To the example texture material described in Table E-3 is added 10-15% by weight of propellant material in the form of DME.

FIG. 23 further illustrates that the first example aerosol dispensing system 20b comprises a conduit 40b defining a conduit passageway 42b. The conduit 40b is supported by the container 30b such that the conduit passageway 42b defines a conduit inlet 44b arranged within the chamber 32b and a conduit outlet 46b arranged outside of the chamber 32b. The conduit outlet 46b may alternatively be referred to herein as an outlet opening 46b. The example conduit 40b is formed by an inlet tube 50b, a valve housing 52b, and an actuator structure 54b. The conduit passageway 42b extends through the inlet tube 50b, the valve housing 52b, and the actuator structure 54b such that the valve housing 52b is arranged between the conduit inlet 44b and the actuator structure 54b and the actuator structure 54b is arranged between the valve housing 52b and the conduit outlet 46b.

Arranged within the valve housing 52b is a valve system 60b. A first flow adjustment system 70b having a first adjustment member 72b is arranged to interface with the valve system 60b. A second flow adjustment system 80b having a second adjustment member 82b is arranged in the conduit passageway 42b to form at least a portion of the conduit outlet 46b.

The valve system 60b operates in a closed configuration, a fully open configuration, and at least one of a continuum or plurality of partially open intermediate configurations. In the closed configuration, the valve system 60b substantially prevents flow of fluid along the conduit passageway 42b. In the open configuration and the at least one intermediate configuration, the valve system 60b allows flow of fluid along the conduit passageway 42b. The valve system 60b is normally in the closed configuration. The valve system 60b engages the actuator member structure 54b and is placed into the open configuration by applying deliberate manual force on the actuator structure 54b towards the container 30b.

The first flow adjustment system 70b is supported by the container 30b to engage the actuator structure such that manual operation of the first adjustment member 72b controls the flow of fluid material along the conduit passageway 42b. In particular, the first adjustment system 70b functions as a flow restrictor, where operation of the first adjustment member 72b results in a variation in the size of a portion of the conduit passageway 42b such that a pressure of the fluid material upstream of the first flow adjustment system 70b is relatively higher than the pressure of the fluid material downstream of the first flow adjustment system 70b.

In general, a primary purpose of the first flow adjustment system 70b is to alter a distance of travel of the dispensed material 22b. The first flow adjustment system 70b may also have a secondary affect on the pattern in which the dispensed material 22b is sprayed.

The second adjustment system 80b is supported by the actuator structure 54b downstream of the first adjustment system 70b. Manual operation of the second adjustment member 82b affects the flow of fluid material flowing out of the conduit passageway 42b through the conduit outlet 46b. In particular, the second adjustment system 80b functions as a variable orifice, where operation of the second adjustment member 72b variably reduces the size of the conduit outlet 46b relative to the size of the conduit passageway 42b upstream of the second adjustment system 80b.

A primary purpose of the second flow adjustment system 80b is to alter a pattern in which the dispensed material 22b is sprayed. The first flow adjustment system 70b may also have a secondary affect on the distance of travel of the dispensed material 22b.

To operate the fifth example aerosol dispensing system 20b (of the second example class of dispensing systems), the container 30b is grasped such that the finger can depress the actuator structure 54b. The conduit outlet or outlet opening 46b is initially aimed at a test surface and the actuator structure 54b is depressed to place the valve system 60b in the open configuration such that the pressurized material 36b forces some of the stored material 34b out of the container 30b and onto the test surface to form a test texture pattern. The test texture pattern is compared to the pre-existing texture pattern defined by the textured portion 26b of the target surface 24b. If the test texture pattern does not match the pre-existing texture pattern, one or both of the first and second adjustment systems 70b and 80b are adjusted to alter the spray pattern of the droplets of dispensed material 22b.

The process of spraying a test pattern and comparing it to the pre-existing pattern and adjusting the first and second adjustment members 72b and 82b is repeated until the dispensed material forms a desired texture pattern that substantially matches the pre-existing texture pattern.

Leaving the first and second adjustment systems 70b and 80b as they were when the test texture pattern matched the pre-existing texture pattern, the aerosol dispensing system 20b is then arranged such that the conduit outlet or outlet opening 46b is aimed at the un-textured portion 28b of the target surface 24b. The actuator structure 54b is again depressed to operate the valve system 60b such that the pressurized material 36b forces the stored material 34b out of the container 30b and onto the un-textured portion 28b of the target surface to form the desired texture pattern.

### A. Sixth Example Aerosol Dispensing System

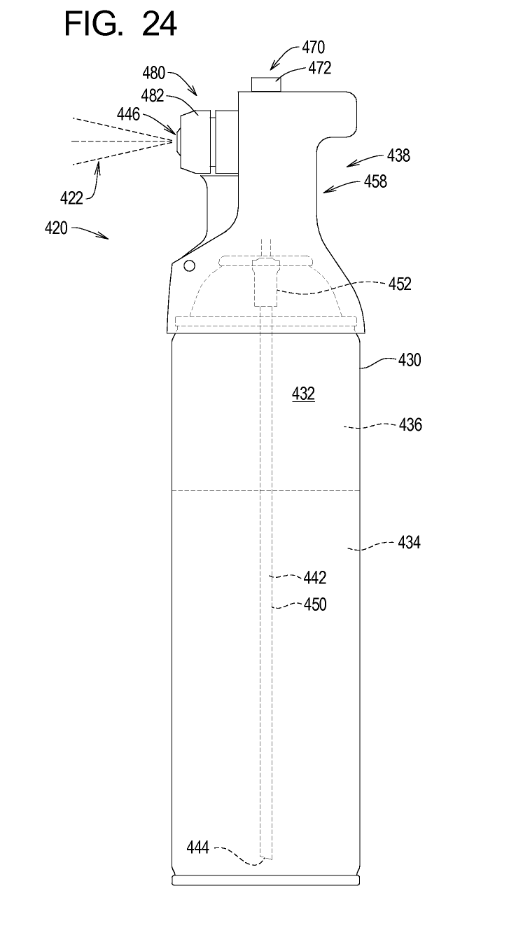

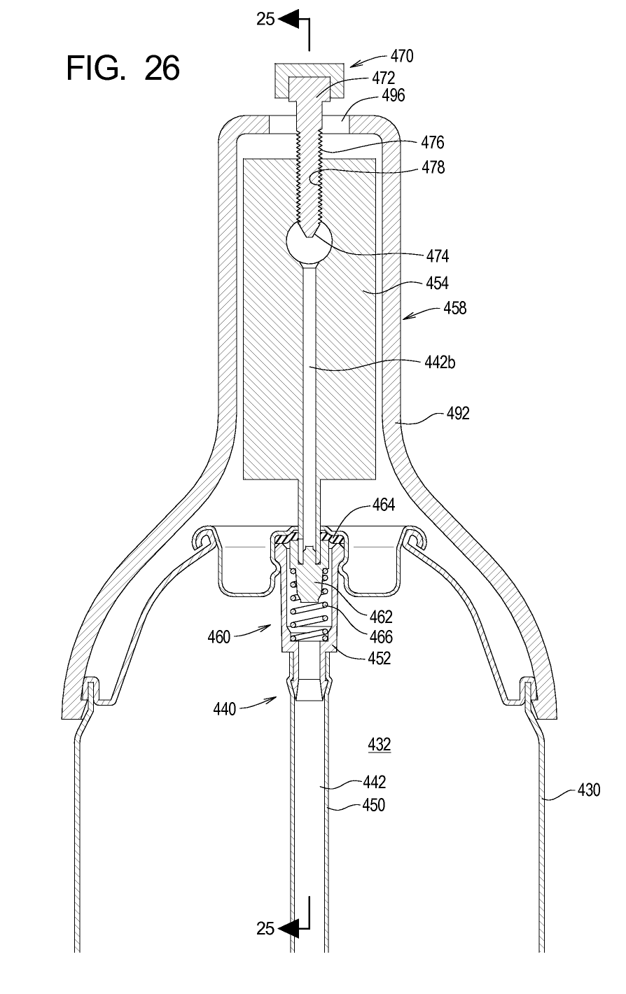

Referring now to FIGS. 24-27 of the drawing, depicted at 420 therein is a sixth example aerosol dispensing system constructed in accordance with, and embodying, the principles of the present invention. Like the fifth example aerosol dispensing system 20b, the sixth example dispensing system is adapted to spray droplets of dispensed material 422 onto a target surface (not shown). In the example use of the dispensing system 420 depicted in FIG. 24, the dispensed material 422 is or contains texture material, and the dispensing system 420 is being used to form a coating on an un-textured portion of the target surface having a desired texture pattern that substantially matches a pre-existing texture pattern of a textured portion of the target surface.

FIG. 24 further illustrates that the example dispensing system 420 comprises a container 430 defining a chamber 432 in which stored material 434 and pressurized material 436 are contained. Like the stored materials (e.g., stored materials 34a and 34b) described above, the stored material 434 is a mixture of texture material and propellant material in liquid phase, while the pressurized material is propellant material in gas phase. An actuator assembly 438 is mounted on the container assembly 430 to facilitate the dispensing of the dispensed material 422 as will be described in further detail below.

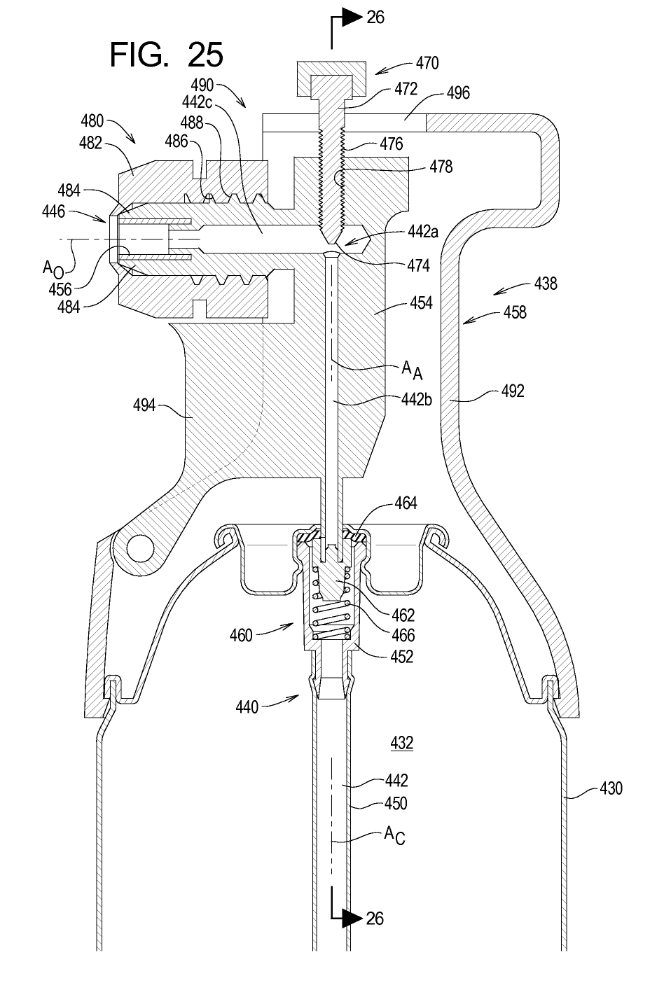

FIG. 25 illustrates that the sixth example aerosol dispensing system 420 comprises a conduit 440 defining a conduit passageway 442. The conduit 440 is supported by the container 430 such that the conduit passageway 442 defines a conduit inlet 444 arranged within the chamber 432 and a conduit outlet or outlet opening 446 arranged outside of the chamber 432. The example conduit 440 is formed by an inlet tube 450, a valve housing 452, an actuator member 454, and an outlet member 456. The conduit passageway 442 extends through the inlet tube 450, the valve housing 452, the actuator member 454, and the outlet member 456. The valve housing 452 is arranged between the conduit inlet 444 and the actuator member 454, and the actuator member 454 is arranged between the valve housing 452 and the conduit outlet 446. The outlet member 456 is supported by the actuator member 454 to define the conduit outlet 446.

FIG. 25 further shows that a valve assembly 460 is formed within the valve housing 452. The example valve assembly 460 comprises a valve member 462, a valve seat 464, and a valve spring 466. The valve assembly 460 operates in a closed configuration and an open configuration. In the closed configuration, the valve spring 466 forces the valve member 462 against the valve seat 464 such that the valve assembly 460 substantially prevents flow of fluid along the conduit passageway 442. In the open configuration, the valve member 462 is displaced away from the valve seat 464 against the force of the valve spring 466 such that the valve assembly 460 allows flow of fluid along the conduit passageway 442 between the valve member 462 and the valve seat 464. Because the valve spring 466 biases the valve member 462 towards the valve seat 464, the example valve assembly 460 is normally closed. As will be described in further detail below, the valve assembly 460 engages the actuator member structure 454 such that the application of deliberate manual force on the actuator member 454 towards the container 430 moves the valve member 462 away from the valve seat 464 and thus places the valve system 460 in the open configuration.

A first flow adjustment system 470 having a first adjustment member 472 having a valve surface 474 and an externally threaded surface 476 is arranged to intersect the conduit passageway 442 at an intermediate location 442a between the valve assembly 460 and the conduit outlet 446. The conduit passageway has a first portion 442b and a second portion 442c. The first passageway portion 442b defines an actuator axis A_{A} aligned with a container axis A_{C} defined by the container assembly 430, and the second actuator passageway portion is aligned with an outlet axis A_{O} defined by the outlet member 456. The example intermediate location 442a is located in the second passageway portion 442c.

An internally threaded surface 478 is formed in the actuator member 454. The threaded surfaces 476 and 478 are adapted to engage each other such that rotation of the first adjustment member 472 relative to the actuator member 454 causes the valve surface 474 to enter the conduit passageway and thus alter a cross-sectional area of the conduit passageway 442 between the valve system 460 and the second flow adjustment system 480.

A second flow adjustment system 480 comprises a second adjustment member 482 and a plurality of fingers 484 extending from the actuator member 454. The second flow adjustment system 480 is arranged relative to the conduit passageway 442 to form at least a portion of the conduit outlet (or outlet opening) 446. The second adjustment member 482 defines an internal threaded surface 486 that engages an external threaded surface 488 of the actuator member 454 such that rotation of the second adjustment member 482 relative to the actuator member 454 deforms the fingers and thus the outlet member 456, thereby altering a cross-sectional area of the conduit outlet or outlet opening 446.

The first flow adjustment system 470 is supported by the actuator member 454 between the valve assembly 460 and the second adjustment system 480 such that manual operation of the first adjustment member 472 affects the flow of fluid material along the conduit passageway 442. In particular, the second adjustment system 480 functions as a flow restrictor, where operation of the first adjustment member 472 variably reduces the size of the conduit passageway 442 such that a pressure of the fluid material upstream of the first flow adjustment system 470 is relatively higher than the pressure of the fluid material downstream of the first flow adjustment system 470. The example first adjustment member 472 is movable between a fully open configuration (smallest amount of restriction) and a terminal configuration (largest amount of restriction).

The second adjustment system 480 is supported by the actuator member 454 downstream of the first adjustment system 470. The outlet member 456 is a resiliently deformable tube, and manual operation of the second adjustment member 482 deforms the walls of the outlet member 456 and thereby affects the flow of fluid material flowing out of the conduit passageway 442 through the conduit outlet or outlet opening 446. The second adjustment system 480 thus functions as a variable orifice. Operation of the second adjustment member 482 variably reduces the size of the conduit outlet or outlet opening 446 relative to the size of the conduit passageway 442 upstream of the second adjustment system 480.

The outlet member 456, first adjustment member 472, and second adjustment member 482 are supported by the actuator member 454 to define a control assembly 490. FIG. 25 further shows that the grip assembly 458 comprises a grip housing 492 and that the actuator member 454 defines a trigger portion 494. To form the actuator assembly 438, the grip assembly 458 is combined with the control assembly 490 by pivotably attaching the actuator member 454 to the grip housing 492. The actuator assembly 438 is supported by the container assembly 430 as generally described above. An elongated slot 496 is formed in the grip housing 492 to allow the second adjustment member 482 to extend through the grip housing 492 without interfering with operation of the actuator member 454 as described herein.

To operate the sixth example aerosol dispensing system 420, the container 430 and grip housing 492 are grasped such that the user's fingers can squeeze the trigger portion 494, thereby depressing the actuator member 454. The conduit outlet or outlet opening 446 is initially aimed at a test surface and the actuator member 454 is depressed to place the valve assembly 460 in the open configuration such that the pressurized material 436 forces some of the stored material 434 out of the container 430 and onto the test surface to form a test texture pattern. The test texture pattern is compared to the pre-existing texture pattern defined by the textured portion of the target surface. If the test texture pattern does not match the pre-existing texture pattern, one or both of the first and second adjustment members is/are adjusted to alter the spray pattern of the droplets of dispensed material 422.

The process of spraying a test pattern and adjusting the first and second adjustment members 472 and 482 is repeated until the test pattern formed by the dispensed material 422 corresponds to a desired texture pattern that substantially matches the pre-existing texture pattern.

Leaving the first and second adjustment members 472 and 482 as they were when the test texture pattern corresponded to the desired texture pattern, the aerosol dispensing system 420 is then arranged such that the conduit outlet or outlet opening 446 is aimed at the un-textured portion of the target surface. The trigger member 494 is again squeezed to place the valve assembly 460 in the open configuration such that the pressurized material 436 forces the stored material 434 out of the container 430 and onto the un-textured portion of the target surface to form the desired texture pattern on the un-textured portion of the target surface, perhaps overlapping slightly with the textured portion of the target surface. Since the desired texture pattern substantially matches the pre-existing texture pattern, the dispensed material forms a coating on the previously un-textured portion of the target surface in a desired texture pattern that substantially matches a physical appearance of the textured portion. One or more layers of primer and/or paint may next be applied over the cured layer of dispensed material.

The following Table F represents example ranges and dimensions for constructing a physical embodiment of a flow adjustment system that may be used as the example first flow adjustment system 470:

TABLE F

| Config. | Units | Example | First Range | Second Range |
|---|---|---|---|---|
| Fully Open | % Passageway | 100 | 95-100 | 90-100 |
| | Square Inches | .00385 | 0.00424- | 0.00578- |
| | | | 0.00347 | 0.00193 |
| Terminal | % Passageway | 12 | 8-16 | 5-20 |
| | Square Inches | .00045 | 0.00050- | 0.00068- |
| | | | 0.00041 | 0.00023 |

### B. Seventh Example Aerosol Dispensing System

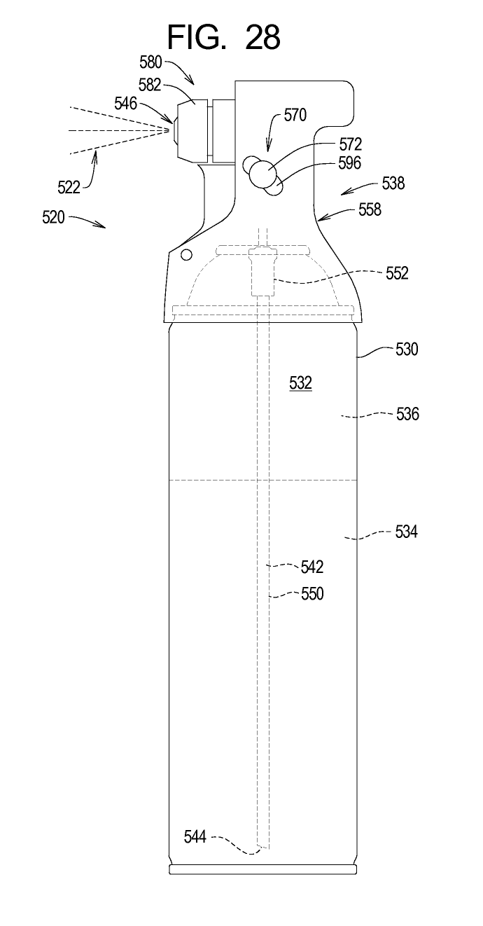

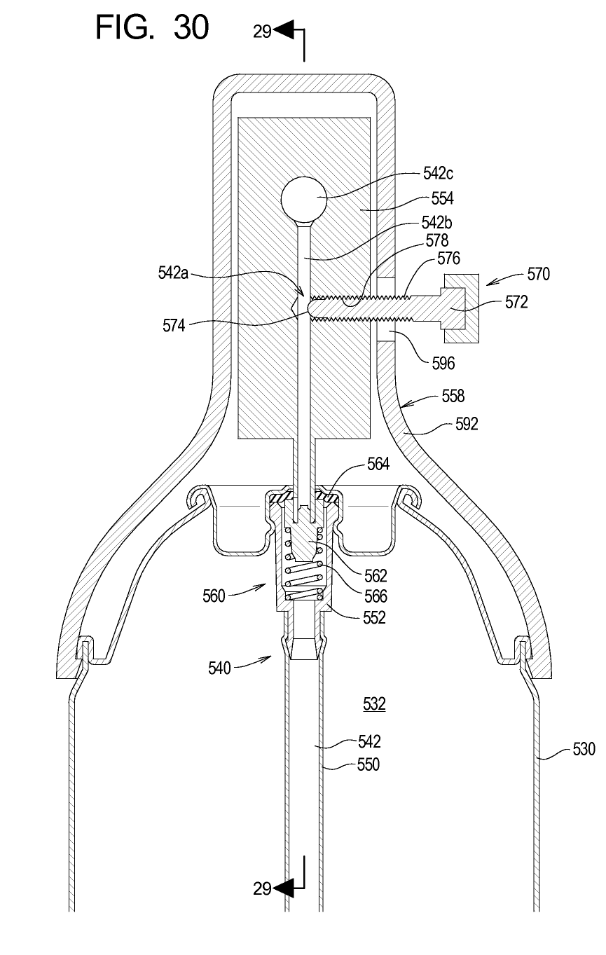

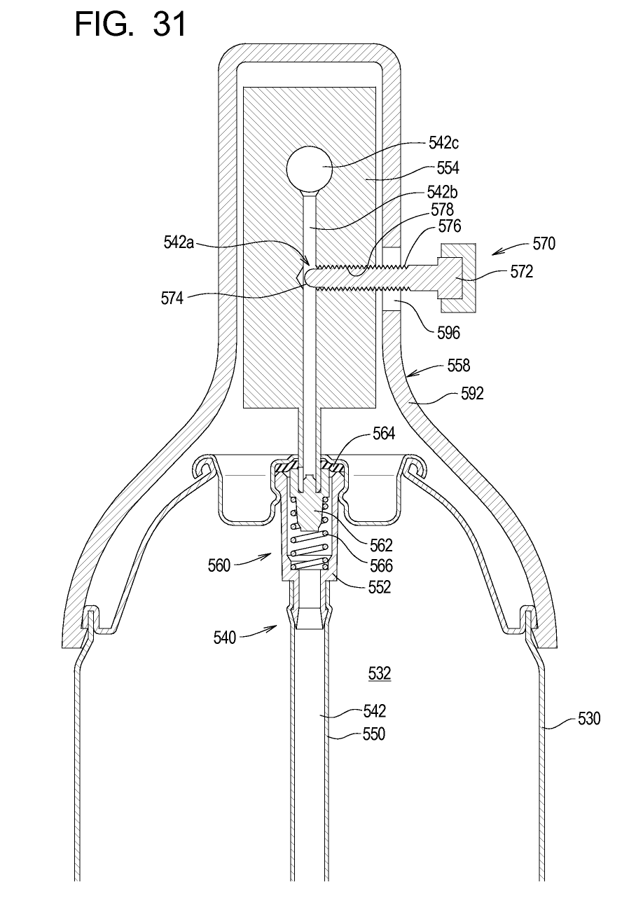

Referring now to FIGS. 28-31 of the drawing, depicted at 520 therein is a seventh example aerosol dispensing system constructed in accordance with, and embodying, the principles of the present invention. Like the fifth example aerosol dispensing system 20b, the seventh example dispensing system is adapted to spray droplets of dispensed material 522 onto a target surface (not shown). In the example use of the dispensing system 520 depicted in FIG. 28, the dispensed material 522 is or contains texture material, and the dispensing system 520 is being used to form a coating on an un-textured portion of the target surface having a desired texture pattern that substantially matches a pre-existing texture pattern of a textured portion of the target surface.

FIG. 28 further illustrates that the example dispensing system 520 comprises a container 530 defining a chamber 532 in which stored material 534 and pressurized material 536 are contained. Like the stored materials (e.g. 34a and 34b) described above, the stored material 534 is a mixture of texture material and propellant material in liquid phase, while the pressurized material is propellant material in gas phase. An actuator assembly 538 is mounted on the container assembly 530 to facilitate the dispensing of the dispensed material 522 as will be described in further detail below.

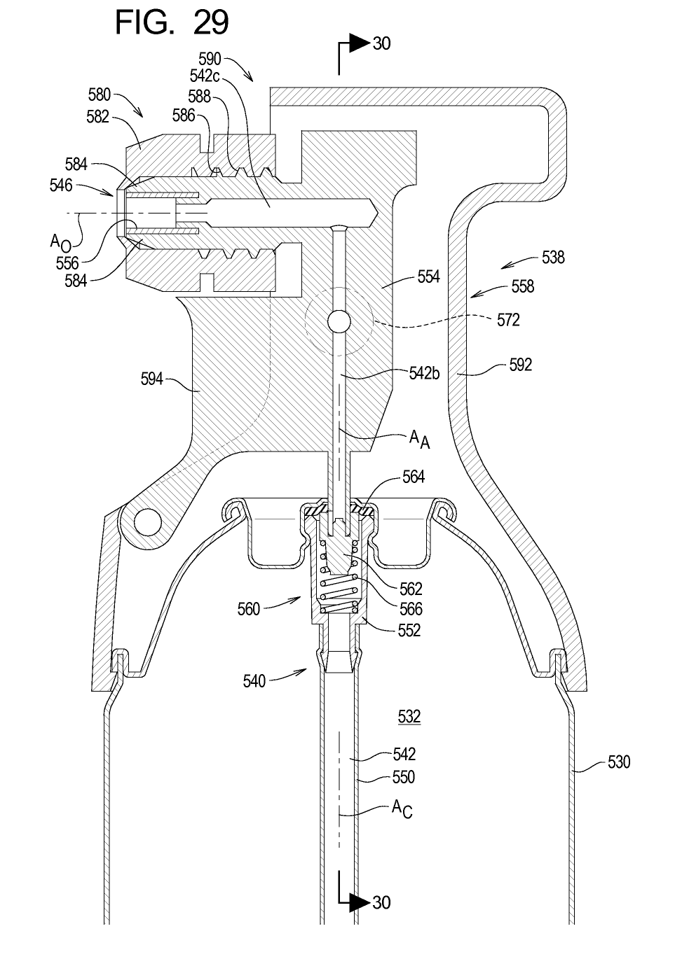

FIG. 29 illustrates that the seventh example aerosol dispensing system 520 comprises a conduit 540 defining a conduit passageway 542. The conduit 540 is supported by the container 530 such that the conduit passageway 542 defines a conduit inlet 544 arranged within the chamber 532 and a conduit outlet or outlet opening 546 arranged outside of the chamber 532. The example conduit 540 is formed by an inlet tube 550, a valve housing 552, an actuator member 554, and an outlet member 556. The conduit passageway 542 extends through the inlet tube 550, the valve housing 552, the actuator member 554, and the outlet member 556. The valve housing 552 is arranged between the conduit inlet 544 and the actuator member 554, and the actuator member 554 is arranged between the valve housing 552 and the conduit outlet 546. The outlet member 556 is supported by the actuator member 554 to define the conduit outlet 546.

FIG. 29 further shows that a valve assembly 560 is formed within the valve housing 552. The example valve assembly 560 comprises a valve member 562, a valve seat 564, and a valve spring 566. The valve assembly 560 operates in a closed configuration and an open configuration. In the closed configuration, the valve spring 566 forces the valve member 562 against the valve seat 564 such that the valve assembly 560 substantially prevents flow of fluid along the conduit passageway 542. In the open configuration, the valve member 562 is displaced away from the valve seat 564 against the force of the valve spring 566 such that the valve assembly 560 allows flow of fluid along the conduit passageway 542 between the valve member 562 and the valve seat 564. Because the valve spring 566 biases the valve member 562 towards the valve seat 564, the example valve assembly 560 is normally closed. As will be described in further detail below, the valve assembly 560 engages the actuator member structure 554 such that the application of deliberate manual force on the actuator member 554 towards the container 530 moves the valve member 562 away from the valve seat 564 and thus places the valve system 560 in the open configuration.

A first flow adjustment system 570 having a first adjustment member 572 having a valve surface 574 and an externally threaded surface 576 is arranged to intersect the conduit passageway 542 at an intermediate location 542a between the valve assembly 560 and the conduit outlet 546. The conduit passageway has a first portion 542b and a second portion 542c. The first passageway portion 542b defines an actuator axis A_{A} aligned with a container axis A_{C} defined by the container assembly 530, and the second actuator passageway portion 542c is aligned with an outlet axis A_{O} defined by the outlet member 556. The example intermediate location 542a is located in the first passageway portion 542b.

An internally threaded surface 578 is formed in the actuator member 554. The threaded surfaces 576 and 578 are adapted to engage each other such that rotation of the first adjustment member 572 relative to the actuator member 554 causes the valve surface 574 to enter the conduit passageway 542 and thus alter a cross-sectional area of the conduit passageway 542 between the valve system 560 and the second flow adjustment system 580.

A second flow adjustment system 580 comprises a second adjustment member 582 and a plurality of fingers 584 extending from the actuator member 554. The second flow adjustment system 580 is arranged relative to the conduit passageway 542 to form at least a portion of the conduit outlet (or outlet opening) 546. The second adjustment member 582 defines an internal threaded surface 586 that engages an external threaded surface 588 of the actuator member 554 such that rotation of the second adjustment member 582 relative to the actuator member 554 deforms the fingers and thus the outlet member 556, thereby altering a cross-sectional area of the conduit outlet or outlet opening 546.

The first flow adjustment system 570 is supported by the actuator member 554 between the valve assembly 560 and the second adjustment system 580 such that manual operation of the first adjustment member 572 affects the flow of fluid material along the conduit passageway 542 as generally described above. In particular, the second adjustment system 580 functions as a flow restrictor, where operation of the first adjustment member 572 variably reduces the size of the conduit passageway 542 such that a pressure of the fluid material upstream of the first flow adjustment system 570 is relatively higher than the pressure of the fluid material downstream of the first flow adjustment system 570. The least amount of restriction created by the first flow adjustment system 570 is associated with a fully open configuration, while the least amount of restriction created by the first flow adjustment system 570 is associated with a terminal configuration.

The second adjustment system 580 is supported by the actuator member 554 downstream of the first adjustment system 570. The outlet member 556 is a resiliently deformable tube, and manual operation of the second adjustment member 582 deforms the walls of the outlet member 556 and thereby affects the flow of fluid material flowing out of the conduit passageway 542 through the conduit outlet or outlet opening 546. The second adjustment system 580 thus functions as a variable orifice. Operation of the second adjustment member 582 variably reduces the size of the conduit outlet or outlet opening 546 relative to the size of the conduit passageway 542 upstream of the second adjustment system 580.

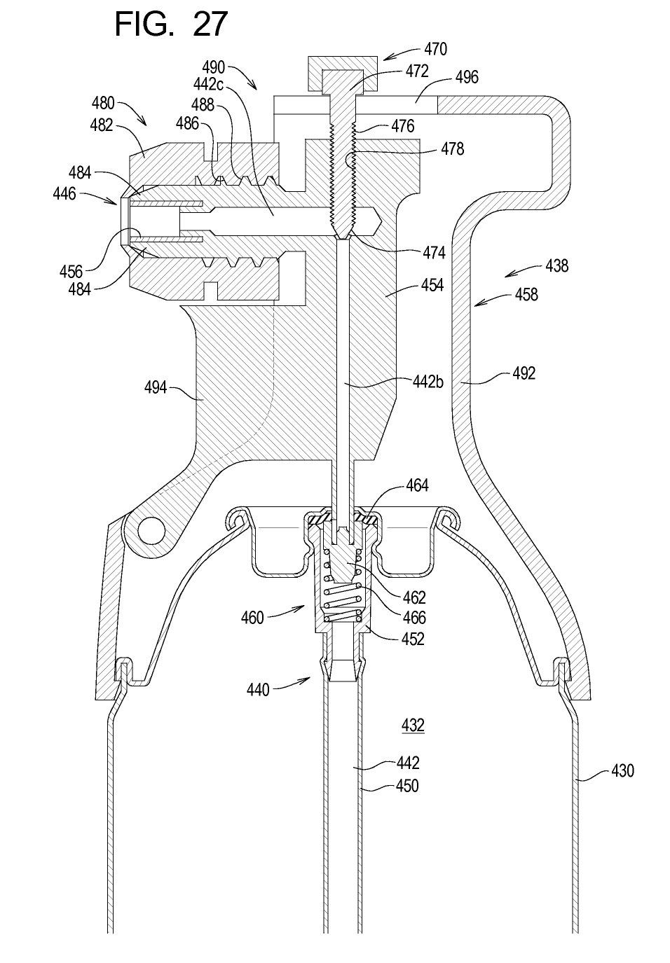

The outlet member 556, first adjustment member 572, and second adjustment member 582 are supported by the actuator member 554 to define a control assembly 590. FIG. 27 further shows that the grip assembly 558 comprises a grip housing 592 and that the actuator member 554 defines a trigger portion 594. To form the actuator assembly 538, the grip assembly 558 is combined with the control assembly 590 by pivotably attaching the actuator member 554 to the grip housing 592. The actuator assembly 538 is supported by the container assembly 530 as generally described above. An elongated slot 596 is formed in the grip housing 592 to allow the second adjustment member 582 to extend through the grip housing 592 without interfering with operation of the actuator member 554 as described herein.

To operate the seventh example aerosol dispensing system 520, the container 530 and grip housing 592 are grasped such that the user's fingers can squeeze the trigger portion 594, thereby depressing the actuator member 554. The conduit outlet or outlet opening 546 is initially aimed at a test surface and the actuator member 554 is depressed to place the valve assembly 560 in the open configuration such that the pressurized material 536 forces some of the stored material 534 out of the container 530 and onto the test surface to form a test texture pattern. The test texture pattern is compared to the pre-existing texture pattern defined by the textured portion of the target surface. If the test texture pattern does not match the pre-existing texture pattern, one or both of the first and second adjustment members is/are adjusted to alter the spray pattern of the droplets of dispensed material 522.

The process of spraying a test pattern and adjusting the first and second adjustment members 572 and 582 is repeated until the test pattern formed by the dispensed material 522 corresponds to a desired texture pattern that substantially matches the pre-existing texture pattern.

Leaving the first and second adjustment members 572 and 582 as they were when the test texture pattern corresponded to the desired texture pattern, the aerosol dispensing system 520 is then arranged such that the conduit outlet or outlet opening 546 is aimed at the un-textured portion of the target surface. The trigger member 594 is again squeezed to place the valve assembly 560 in the open configuration such that the pressurized material 536 forces the stored material 534 out of the container 530 and onto the un-textured portion of the target surface to form the desired texture pattern on the un-textured portion of the target surface, perhaps overlapping slightly with the textured portion of the target surface. Since the desired texture pattern substantially matches the pre-existing texture pattern, the dispensed material forms a coating on the previously un-textured portion of the target surface in a desired texture pattern that substantially matches a physical appearance of the textured portion. One or more layers of primer and/or paint may next be applied over the cured layer of dispensed material.

The following Table G represents example ranges and dimensions for constructing a physical embodiment of a flow adjustment system that may be used as the example first flow adjustment system 570:

TABLE G

| Config. | Units | Example | First Range | Second Range |
|---|---|---|---|---|
| Fully Open | % Passageway | 100 | 95-100 | 90-100 |
| | Square Inches | .00385 | 0.00424- | 0.00578- |
| | | | 0.00347 | 0.00193 |
| Terminal | % Passageway | 12 | 8-16 | 5-20 |
| | Square Inches | .00045 | 0.00050- | 0.00068- |
| | | | 0.00041 | 0.00023 |

### C. Eighth Example Aerosol Dispensing System

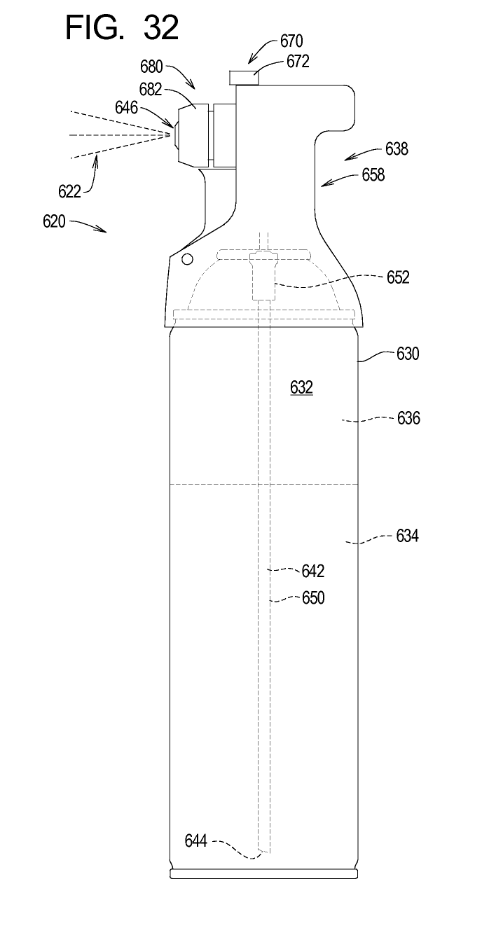

Referring now to FIGS. 32-34 of the drawing, depicted at 620 therein is a eighth example aerosol dispensing system constructed in accordance with, and embodying, the principles of the present invention. Like the fifth example aerosol dispensing system 20b, the eighth example dispensing system is adapted to spray droplets of dispensed material 622 onto a target surface (not shown). In the example use of the dispensing system 620 depicted in FIG. 32, the dispensed material 622 is or contains texture material, and the dispensing system 620 is being used to form a coating on an un-textured portion of the target surface having a desired texture pattern that substantially matches a pre-existing texture pattern of a textured portion of the target surface.

FIG. 32 further illustrates that the example dispensing system 620 comprises a container 630 defining a chamber 632 in which stored material 634 and pressurized material 636 are contained. Like the stored materials (e.g., 34a and 34b) described above, the stored material 634 is a mixture of texture material and propellant material in liquid phase, while the pressurized material is propellant material in gas phase. An actuator assembly 638 is mounted on the container assembly 630 to facilitate the dispensing of the dispensed material 622 as will be described in further detail below.

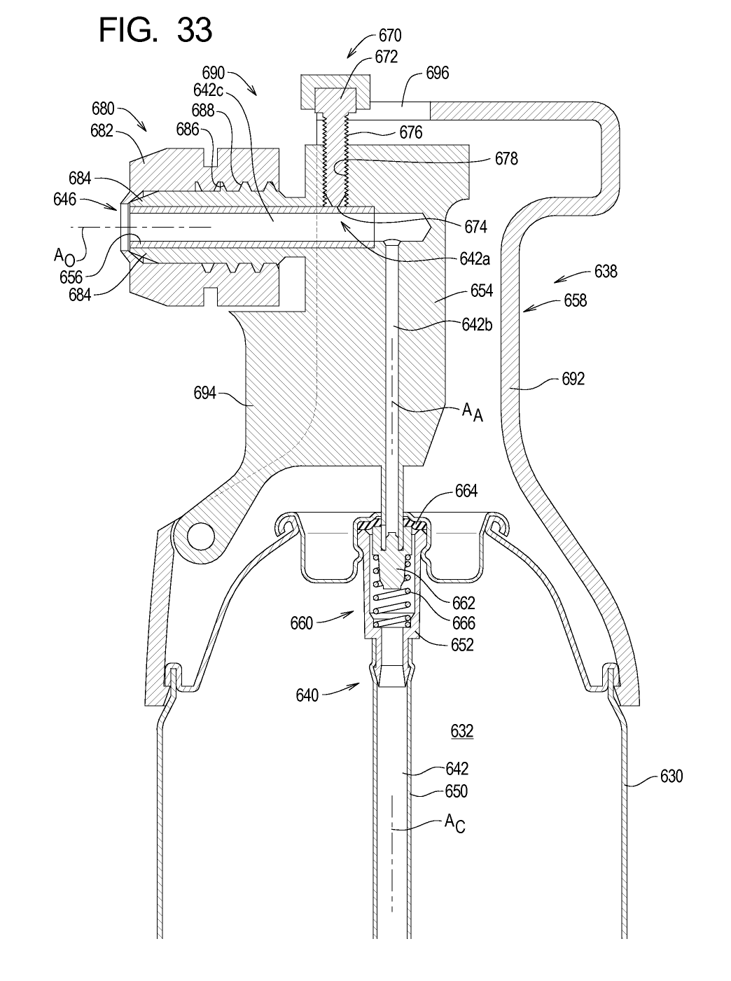

FIG. 33 illustrates that the eighth example aerosol dispensing system 620 comprises a conduit 640 defining a conduit passageway 642. The conduit 640 is supported by the container 630 such that the conduit passageway 642 defines a conduit inlet 644 arranged within the chamber 632 and a conduit outlet or outlet opening 646 arranged outside of the chamber 632. The example conduit 640 is formed by an inlet tube 650, a valve housing 652, an actuator member 654, and an outlet member 656. The conduit passageway 642 extends through the inlet tube 650, the valve housing 652, the actuator member 654, and the outlet member 656. The valve housing 652 is arranged between the conduit inlet 644 and the actuator member 654, and the actuator member 654 is arranged between the valve housing 652 and the conduit outlet 646. The outlet member 656 is supported by the actuator member 654 to define the conduit outlet 646.

FIG. 33 further shows that a valve assembly 660 is formed within the valve housing 652. The example valve assembly 660 comprises a valve member 662, a valve seat 664, and a valve spring 666. The valve assembly 660 operates in a closed configuration and an open configuration. In the closed configuration, the valve spring 666 forces the valve member 662 against the valve seat 664 such that the valve assembly 660 substantially prevents flow of fluid along the conduit passageway 642. In the open configuration, the valve member 662 is displaced away from the valve seat 664 against the force of the valve spring 666 such that the valve assembly 660 allows flow of fluid along the conduit passageway 642 between the valve member 662 and the valve seat 664. Because the valve spring 666 biases the valve member 662 towards the valve seat 664, the example valve assembly 660 is normally closed. As will be described in further detail below, the valve assembly 660 engages the actuator member structure 654 such that the application of deliberate manual force on the actuator member 654 towards the container 630 moves the valve member 662 away from the valve seat 664 and thus places the valve system 660 in the open configuration.

A first flow adjustment system 670 having a first adjustment member 672 having a valve surface 674 and an externally threaded surface 676 is arranged to intersect the conduit passageway 642 at an intermediate location 642a between the valve assembly 660 and the conduit outlet 646. The conduit passageway has a first portion 642b and a second portion 642c. The first passageway portion 642b defines an actuator axis A_{A} aligned with a container axis A_{C} defined by the container assembly 630, and the second actuator passageway portion 642c is aligned with an outlet axis A_{O} defined by the outlet member 656. The example intermediate location 642a is located in the second passageway portion 642c.

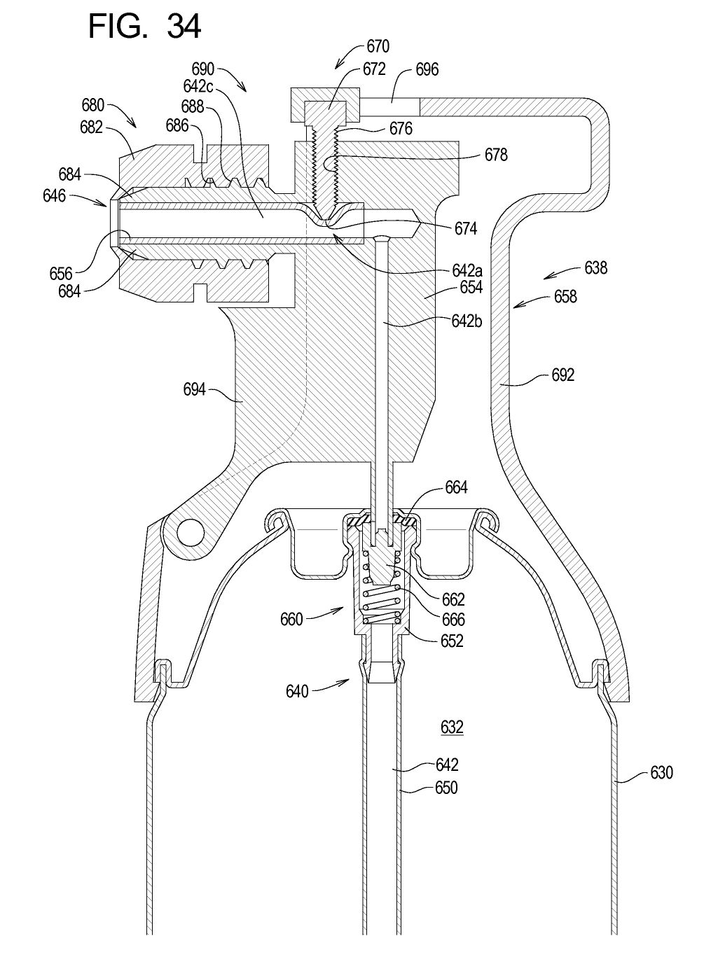

An internally threaded surface 678 is formed in the actuator member 654. The threaded surfaces 676 and 678 are adapted to engage each other such that, as shown in FIG. 34, rotation of the first adjustment member 672 relative to the actuator member 654 causes the valve surface 674 to engage and deform the outlet member 656 and thus alter a cross-sectional area of the conduit passageway 642 between the valve system 660 and the second flow adjustment system 680.

A second flow adjustment system 680 comprises a second adjustment member 682 and a plurality of fingers 684 extending from the actuator member 654. The second flow adjustment system 680 is arranged relative to the conduit passageway 642 to form at least a portion of the conduit outlet (or outlet opening) 646. The second adjustment member 682 defines an internal threaded surface 686 that engages an external threaded surface 688 of the actuator member 654 such that rotation of the second adjustment member 682 relative to the actuator member 654 deforms the fingers and thus the outlet member 656, thereby altering a cross-sectional area of the conduit outlet or outlet opening 646.

The first flow adjustment system 670 is supported by the actuator member 654 between the valve assembly 660 and the second adjustment system 680 such that manual operation of the first adjustment member 672 affects the flow of fluid material along the conduit passageway 642 as generally described above. In particular, the second adjustment system 680 functions as a flow restrictor, where operation of the first adjustment member 672 variably reduces the size of the conduit passageway 642 such that a pressure of the fluid material upstream of the first flow adjustment system 670 is relatively higher than the pressure of the fluid material downstream of the first flow adjustment system 670. The first flow adjustment system 670 defines a fully open configuration (smallest restriction) and a terminal configuration (largest restriction).

The second adjustment system 680 is supported by the actuator member 654 downstream of the first adjustment system 670. The outlet member 656 is a resiliently deformable tube, and manual operation of the second adjustment member 682 deforms the walls of the outlet member 656 and thereby affects the flow of fluid material flowing out of the conduit passageway 642 through the conduit outlet or outlet opening 646. The second adjustment system 680 thus functions as a variable orifice. Operation of the second adjustment member 682 variably reduces the size of the conduit outlet or outlet opening 646 relative to the size of the conduit passageway 642 upstream of the second adjustment system 680.

The outlet member 656, first adjustment member 672, and second adjustment member 682 are supported by the actuator member 654 to define a control assembly 690. FIG. 33 further shows that the grip assembly 658 comprises a grip housing 692 and that the actuator member 654 defines a trigger portion 694. To form the actuator assembly 638, the grip assembly 658 is combined with the control assembly 690 by pivotably attaching the actuator member 654 to the grip housing 692. The actuator assembly 638 is supported by the container assembly 630 as generally described above. An elongated slot 696 is formed in the grip housing 692 to allow the first adjustment member 672 to extend through the grip housing 692 without interfering with operation of the actuator member 654 as described herein.

To operate the eighth example aerosol dispensing system 620, the container 630 and grip housing 692 are grasped such that the user's fingers can squeeze the trigger portion 694, thereby depressing the actuator member 654. The conduit outlet or outlet opening 646 is initially aimed at a test surface and the actuator member 654 is depressed to place the valve assembly 660 in the open configuration such that the pressurized material 636 forces some of the stored material 634 out of the container 630 and onto the test surface to form a test texture pattern. The test texture pattern is compared to the pre-existing texture pattern defined by the textured portion of the target surface. If the test texture pattern does not match the pre-existing texture pattern, one or both of the first and second adjustment members is/are adjusted to alter the spray pattern of the droplets of dispensed material 622.

The process of spraying a test pattern and adjusting the first and second adjustment members 672 and 682 is repeated until the test pattern formed by the dispensed material 622 corresponds to a desired texture pattern that substantially matches the pre-existing texture pattern.

Leaving the first and second adjustment members 672 and 682 as they were when the test texture pattern corresponded to the desired texture pattern, the aerosol dispensing system 620 is then arranged such that the conduit outlet or outlet opening 646 is aimed at the un-textured portion of the target surface. The trigger member 694 is again squeezed to place the valve assembly 660 in the open configuration such that the pressurized material 636 forces the stored material 634 out of the container 630 and onto the un-textured portion of the target surface to form the desired texture pattern on the un-textured portion of the target surface, perhaps overlapping slightly with the textured portion of the target surface. Since the desired texture pattern substantially matches the pre-existing texture pattern, the dispensed material forms a coating on the previously un-textured portion of the target surface in a desired texture pattern that substantially matches a physical appearance of the textured portion. One or more layers of primer and/or paint may next be applied over the cured layer of dispensed material.

The following Table H represents example ranges and dimensions for constructing a physical embodiment of a flow adjustment system that may be used as the example first flow adjustment system 670:

TABLE H

| Config. | Units | Example | First Range | Second Range |
|---|---|---|---|---|
| Fully Open | % Passageway | 100 | 95-100 | 90-100 |
| | Square Inches | .00385 | 0.00424- | 0.00578- |
| | | | 0.00347 | 0.00193 |
| Terminal | % Passageway | 12 | 8-16 | 5-20 |
| | Square Inches | .00045 | 0.00050- | 0.00068- |
| | | | 0.00041 | 0.00023 |

### D. Ninth Example Aerosol Dispensing System

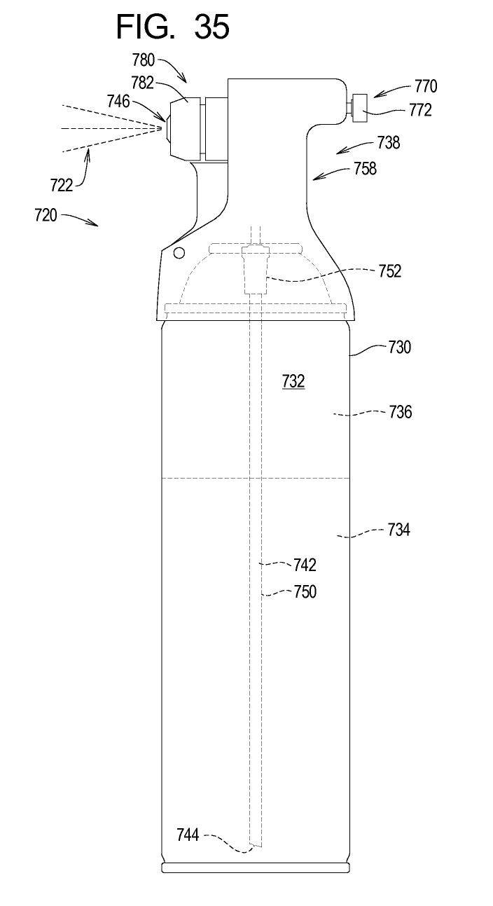

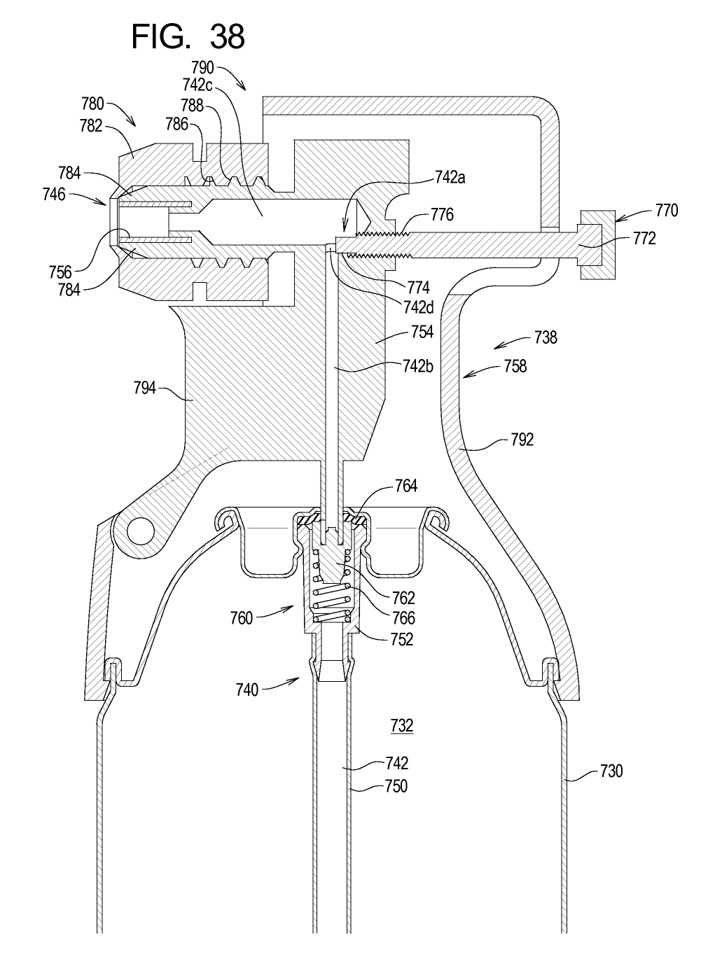

Referring now to FIGS. 35-38 of the drawing, depicted at 720 therein is a ninth example aerosol dispensing system constructed in accordance with, and embodying, the principles of the present invention. Like the fifth example aerosol dispensing system 20b, the ninth example dispensing system is adapted to spray droplets of dispensed material 722 onto a target surface (not shown). In the example use of the dispensing system 720 depicted in FIG. 35, the dispensed material 722 is or contains texture material, and the dispensing system 720 is being used to form a coating on an un-textured portion of the target surface having a desired texture pattern that substantially matches a pre-existing texture pattern of a textured portion of the target surface.

FIG. 35 further illustrates that the example dispensing system 720 comprises a container 730 defining a chamber 732 in which stored material 734 and pressurized material 736 are contained. Like the stored materials (e.g., 34a and 34b) described above, the stored material 734 is a mixture of texture material and propellant material in liquid phase, while the pressurized material is propellant material in gas phase. An actuator assembly 738 is mounted on the container assembly 730 to facilitate the dispensing of the dispensed material 722 as will be described in further detail below.

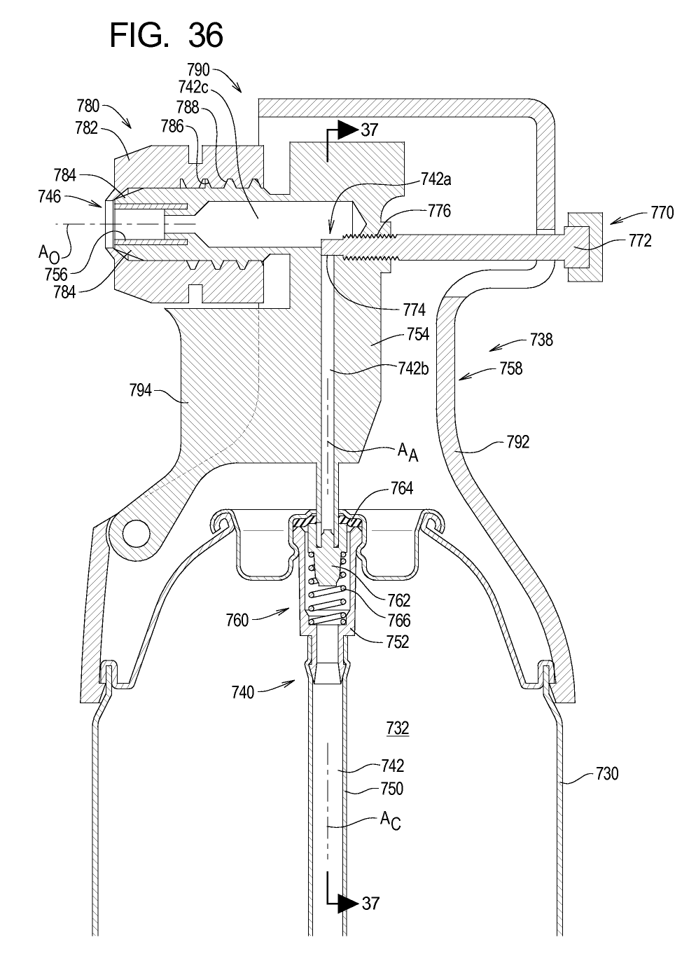

FIG. 36 illustrates that the ninth example aerosol dispensing system 720 comprises a conduit 740 defining a conduit passageway 742. The conduit 740 is supported by the container 730 such that the conduit passageway 742 defines a conduit inlet 744 arranged within the chamber 732 and a conduit outlet or outlet opening 746 arranged outside of the chamber 732. The example conduit 740 is formed by an inlet tube 750, a valve housing 752, an actuator member 754, and an outlet member 756. The conduit passageway 742 extends through the inlet tube 750, the valve housing 752, the actuator member 754, and the outlet member 756. The valve housing 752 is arranged between the conduit inlet 744 and the actuator member 754, and the actuator member 754 is arranged between the valve housing 752 and the conduit outlet 746. The outlet member 756 is supported by the actuator member 754 to define the conduit outlet 746.

FIG. 36 further shows that a valve assembly 760 is formed within the valve housing 752. The example valve assembly 760 comprises a valve member 762, a valve seat 764, and a valve spring 766. The valve assembly 760 operates in a closed configuration and an open configuration. In the closed configuration, the valve spring 766 forces the valve member 762 against the valve seat 764 such that the valve assembly 760 substantially prevents flow of fluid along the conduit passageway 742. In the open configuration, the valve member 762 is displaced away from the valve seat 764 against the force of the valve spring 766 such that the valve assembly 760 allows flow of fluid along the conduit passageway 742 between the valve member 762 and the valve seat 764. Because the valve spring 766 biases the valve member 762 towards the valve seat 764, the example valve assembly 760 is normally closed. As will be described in further detail below, the valve assembly 760 engages the actuator member structure 754 such that the application of deliberate manual force on the actuator member 754 towards the container 730 moves the valve member 762 away from the valve seat 764 and thus places the valve system 760 in the open configuration.

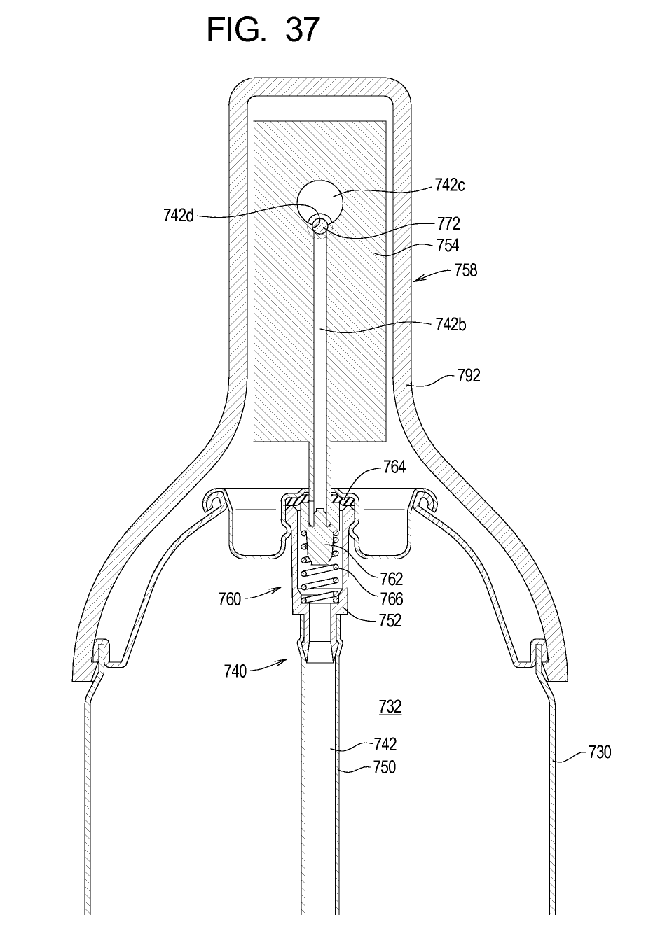

A first flow adjustment system 770 having a first adjustment member 772 having a valve surface 774 and an externally threaded surface 776 is arranged to intersect the conduit passageway 742 at an intermediate location 742a between the valve assembly 760 and the conduit outlet 746. The conduit passageway has a first portion 742b and a second portion 742c. The first passageway portion 742b defines an actuator axis A_{A} aligned with a container axis A_{C} defined by the container assembly 730, and the second actuator passageway portion 742c is aligned with an outlet axis A_{O} defined by the outlet member 756. The example intermediate location 742a is located at the juncture of the first and second passageway portions 742b and 742c. A juncture surface 742d having a profile that matches that of the valve surface 774 is arranged at the intermediate location 742a as perhaps best shown in FIG. 37.

An internally threaded surface 778 is formed in the actuator member 754. The threaded surfaces 776 and 778 are adapted to engage each other such that, as shown in FIG. 34, rotation of the first adjustment member 772 relative to the actuator member 754 causes the valve surface 774 move into the conduit passageway 742 and thus alter a cross-sectional area of the conduit passageway 742 between the valve system 760 and the second flow adjustment system 780.

A second flow adjustment system 780 comprises a second adjustment member 782 and a plurality of fingers 784 extending from the actuator member 754. The second flow adjustment system 780 is arranged relative to the conduit passageway 742 to form at least a portion of the conduit outlet (or outlet opening) 746. The second adjustment member 782 defines an internal threaded surface 786 that engages an external threaded surface 788 of the actuator member 754 such that rotation of the second adjustment member 782 relative to the actuator member 754 deforms the fingers and thus the outlet member 756, thereby altering a cross-sectional area of the conduit outlet or outlet opening 746.

The first flow adjustment system 770 is supported by the actuator member 754 between the valve assembly 760 and the second adjustment system 780 such that manual operation of the first adjustment member 772 affects the flow of fluid material along the conduit passageway 742 as generally described above. In particular, the second adjustment system 780 functions as a flow restrictor, where operation of the first adjustment member 772 variably reduces the size of the conduit passageway 742 such that a pressure of the fluid material upstream of the first flow adjustment system 770 is relatively higher than the pressure of the fluid material downstream of the first flow adjustment system 770. The example first flow adjustment system 770 operates in a fully open configuration (least amount of flow restriction) and a terminal configuration (largest amount of flow restriction).

The second adjustment system 780 is supported by the actuator member 754 downstream of the first adjustment system 770. The outlet member 756 is a resiliently deformable tube, and manual operation of the second adjustment member 782 deforms the walls of the outlet member 756 and thereby affects the flow of fluid material flowing out of the conduit passageway 742 through the conduit outlet or outlet opening 746. The second adjustment system 780 thus functions as a variable orifice. Operation of the second adjustment member 782 variably reduces the size of the conduit outlet or outlet opening 746 relative to the size of the conduit passageway 742 upstream of the second adjustment system 780.

The outlet member 756, first adjustment member 772, and second adjustment member 782 are supported by the actuator member 754 to define a control assembly 790. FIG. 36 further shows that the grip assembly 758 comprises a grip housing 792 and that the actuator member 754 defines a trigger portion 794. To form the actuator assembly 738, the grip assembly 758 is combined with the control assembly 790 by pivotably attaching the actuator member 754 to the grip housing 792. The actuator assembly 738 is supported by the container assembly 730 as generally described above. An elongated slot 796 is formed in the grip housing 792 to allow the first adjustment member 772 to extend through the grip housing 792 without interfering with operation of the actuator member 754 as described herein.

To operate the ninth example aerosol dispensing system 720, the container 730 and grip housing 792 are grasped such that the user's fingers can squeeze the trigger portion 794, thereby depressing the actuator member 754. The conduit outlet or outlet opening 746 is initially aimed at a test surface and the actuator member 754 is depressed to place the valve assembly 760 in the open configuration such that the pressurized material 736 forces some of the stored material 734 out of the container 730 and onto the test surface to form a test texture pattern. The test texture pattern is compared to the pre-existing texture pattern defined by the textured portion of the target surface. If the test texture pattern does not match the pre-existing texture pattern, one or both of the first and second adjustment members is/are adjusted to alter the spray pattern of the droplets of dispensed material 722.

The process of spraying a test pattern and adjusting the first and second adjustment members 772 and 782 is repeated until the test pattern formed by the dispensed material 722 corresponds to a desired texture pattern that substantially matches the pre-existing texture pattern.

Leaving the first and second adjustment members 772 and 782 as they were when the test texture pattern corresponded to the desired texture pattern, the aerosol dispensing system 720 is then arranged such that the conduit outlet or outlet opening 746 is aimed at the un-textured portion of the target surface. The trigger member 794 is again squeezed to place the valve assembly 760 in the open configuration such that the pressurized material 736 forces the stored material 734 out of the container 730 and onto the un-textured portion of the target surface to form the desired texture pattern on the un-textured portion of the target surface, perhaps overlapping slightly with the textured portion of the target surface. Since the desired texture pattern substantially matches the pre-existing texture pattern, the dispensed material forms a coating on the previously un-textured portion of the target surface in a desired texture pattern that substantially matches a physical appearance of the textured portion. One or more layers of primer and/or paint may next be applied over the cured layer of dispensed material.

The following Table I represents example ranges and dimensions for constructing a physical embodiment of a flow adjustment system that may be used as the example first flow adjustment system 770:

TABLE I

| Config. | Units | Example | First Range | Second Range |
|---|---|---|---|---|
| Fully Open | % Passageway | 100 | 95-100 | 90-100 |
| | Square Inches | .00385 | 0.00424- | 0.00578- |
| | | | 0.00347 | 0.00193 |
| Terminal | % Passageway | 12 | 8-16 | 5-20 |
| | Square Inches | .00045 | 0.00050- | 0.00068- |
| | | | 0.00041 | 0.00023 |

### E. Tenth Example Aerosol Dispensing System

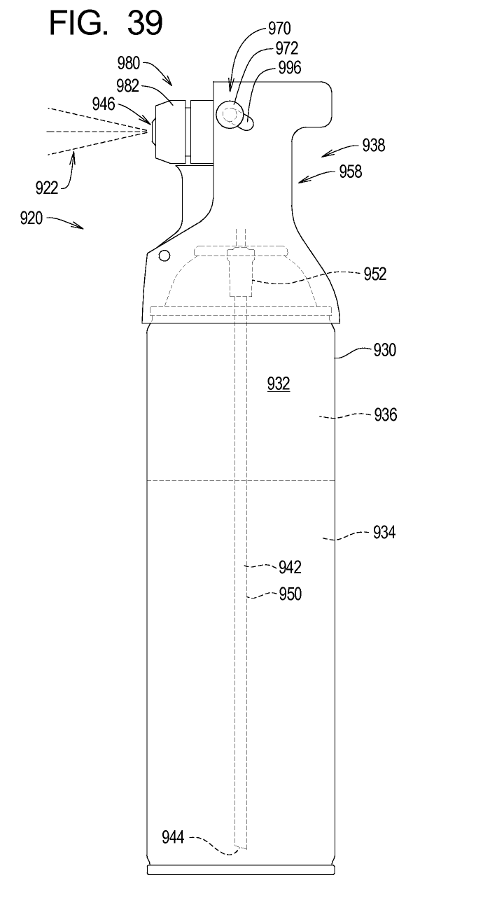

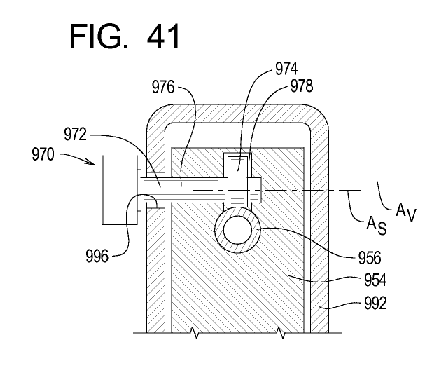

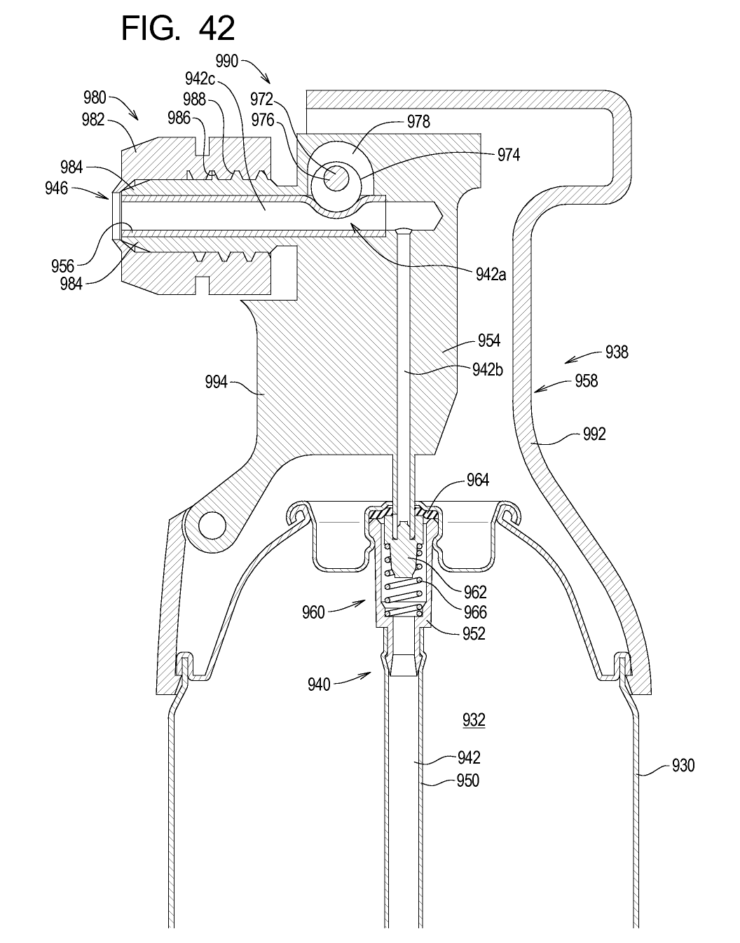

Referring now to FIGS. 39-42 of the drawing, depicted at 920 therein is a tenth example aerosol dispensing system constructed in accordance with, and embodying, the principles of the present invention. Like the fifth example aerosol dispensing system 20b, the tenth example dispensing system is adapted to spray droplets of dispensed material 922 onto a target surface (not shown). In the example use of the dispensing system 920 depicted in FIG. 39, the dispensed material 922 is or contains texture material, and the dispensing system 920 is being used to form a coating on an un-textured portion of the target surface having a desired texture pattern that substantially matches a pre-existing texture pattern of a textured portion of the target surface.

FIG. 39 further illustrates that the example dispensing system 920 comprises a container 930 defining a chamber 932 in which stored material 934 and pressurized material 936 are contained. Like the stored materials (e.g., 34a and 34b) described above, the stored material 934 is a mixture of texture material and propellant material in liquid phase, while the pressurized material is propellant material in gas phase. An actuator assembly 938 is mounted on the container assembly 930 to facilitate the dispensing of the dispensed material 922 as will be described in further detail below.

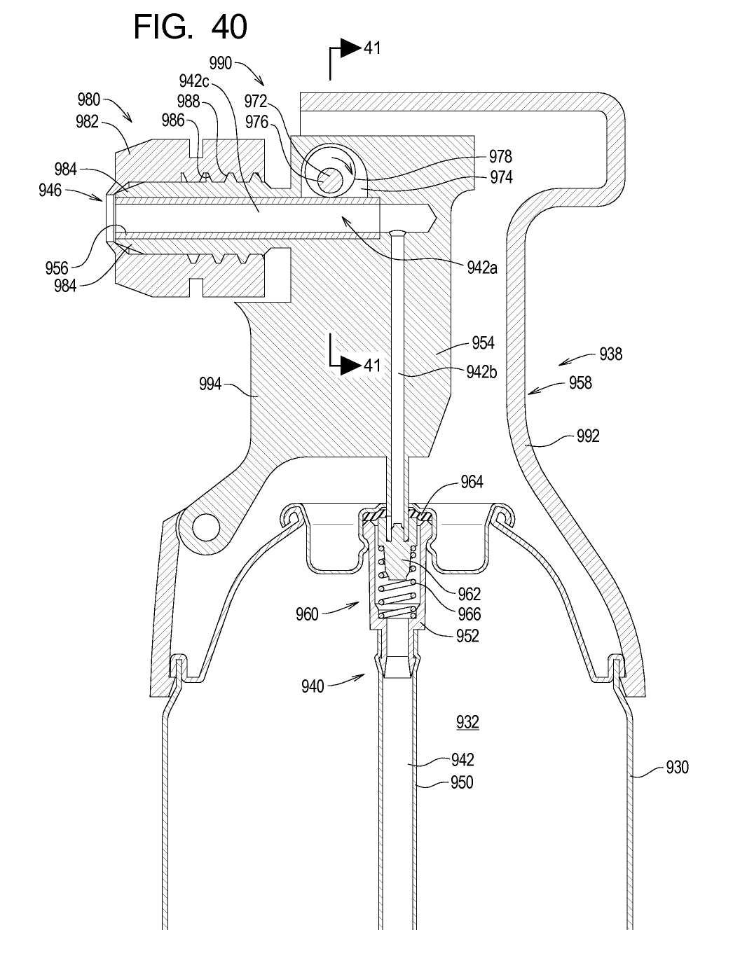

FIG. 40 illustrates that the tenth example aerosol dispensing system 920 comprises a conduit 940 defining a conduit passageway 942. The conduit 940 is supported by the container 930 such that the conduit passageway 942 defines a conduit inlet 944 arranged within the chamber 932 and a conduit outlet or outlet opening 946 arranged outside of the chamber 932. The example conduit 940 is formed by an inlet tube 950, a valve housing 952, an actuator member 954, and an outlet member 956. The conduit passageway 942 extends through the inlet tube 950, the valve housing 952, the actuator member 954, and the outlet member 956. The valve housing 952 is arranged between the conduit inlet 944 and the actuator member 954, and the actuator member 954 is arranged between the valve housing 952 and the conduit outlet 946. The outlet member 956 is supported by the actuator member 954 to define the conduit outlet 946.

FIG. 40 further shows that a valve assembly 960 is formed within the valve housing 952. The example valve assembly 960 comprises a valve member 962, a valve seat 964, and a valve spring 966. The valve assembly 960 operates in a closed configuration and an open configuration. In the closed configuration, the valve spring 966 forces the valve member 962 against the valve seat 964 such that the valve assembly 960 substantially prevents flow of fluid along the conduit passageway 942. In the open configuration, the valve member 962 is displaced away from the valve seat 964 against the force of the valve spring 966 such that the valve assembly 960 allows flow of fluid along the conduit passageway 942 between the valve member 962 and the valve seat 964. Because the valve spring 966 biases the valve member 962 towards the valve seat 964, the example valve assembly 960 is normally closed. As will be described in further detail below, the valve assembly 960 engages the actuator member structure 954 such that the application of deliberate manual force on the actuator member 954 towards the container 930 moves the valve member 962 away from the valve seat 964 and thus places the valve system 960 in the open configuration.

A first flow adjustment system 970 having a first adjustment member 972 having a valve surface 974 and a shaft portion 976 is arranged to intersect the conduit passageway 942 at an intermediate location 942a between the valve assembly 960 and the conduit outlet 946. The conduit passageway has a first portion 942b and a second portion 942c. The first passageway portion 942b defines an actuator axis A_{A} aligned with a container axis A_{C} defined by the container assembly 930, and the second actuator passageway portion is aligned with an outlet axis A_{O} defined by the outlet member 956. The example intermediate location 942a is located in the second passageway portion 942c.

A support opening 978 is formed in the actuator member 954. The shaft 976 extends through the opening 978 such that, as shown in FIGS. 45 and 47, rotation of the first adjustment member 972 relative to the actuator member 954 causes the valve surface 974 to engage and deform the outlet member 956 and thus alter a cross-sectional area of the conduit passageway 942 between the valve system 960 and the second flow adjustment system 980. In particular, the valve surface 974 defines a valve axis A_{V} that is offset from a shaft axis A_{S} defined by the shaft portion 976. Accordingly, rotation of the first adjustment member 972 about the shaft axis A_{S} causes eccentric rotation of the valve surface 974. Because of this eccentric rotation, a distance between the portion of the valve surface 974 in contact with the outlet member 956, relative to the shaft axis A_{S}, increases and decreases based on an angular position of the first adjustment member 972.

A second flow adjustment system 980 comprises a second adjustment member 982 and a plurality of fingers 984 extending from the actuator member 954. The second flow adjustment system 980 is arranged relative to the conduit passageway 942 to form at least a portion of the conduit outlet (or outlet opening) 946. The second adjustment member 982 defines an internal threaded surface 986 that engages an external threaded surface 988 of the actuator member 954 such that rotation of the second adjustment member 982 relative to the actuator member 954 deforms the fingers and thus the outlet member 956, thereby altering a cross-sectional area of the conduit outlet or outlet opening 946.

The first flow adjustment system 970 is supported by the actuator member 954 between the valve assembly 960 and the second adjustment system 980 such that manual operation of the first adjustment member 972 affects the flow of fluid material along the conduit passageway 942 as generally described above. In particular, the second adjustment system 980 functions as a flow restrictor, where operation of the first adjustment member 972 variably reduces the size of the conduit passageway 942 such that a pressure of the fluid material upstream of the first flow adjustment system 970 is relatively higher than the pressure of the fluid material downstream of the first flow adjustment system 970. The example first flow adjustment system 970 thus is operable in a fully open configuration (least amount of flow restriction) and a terminal configuration (greatest amount of flow restriction).

The second adjustment system 980 is supported by the actuator member 954 downstream of the first adjustment system 970. The outlet member 956 is a resiliently deformable tube, and manual operation of the second adjustment member 982 deforms the walls of the outlet member 956 and thereby affects the flow of fluid material flowing out of the conduit passageway 942 through the conduit outlet or outlet opening 946. The second adjustment system 980 thus functions as a variable orifice. Operation of the second adjustment member 982 variably reduces the size of the conduit outlet or outlet opening 946 relative to the size of the conduit passageway 942 upstream of the second adjustment system 980.

The outlet member 956, first adjustment member 972, and second adjustment member 982 are supported by the actuator member 954 to define a control assembly 990. FIG. 40 further shows that the grip assembly 958 comprises a grip housing 992 and that the actuator member 954 defines a trigger portion 994. To form the actuator assembly 938, the grip assembly 958 is combined with the control assembly 990 by pivotably attaching the actuator member 954 to the grip housing 992. The actuator assembly 938 is supported by the container assembly 930 as generally described above. An elongated slot 996 is formed in the grip housing 992 to allow the first adjustment member 972 to extend through the grip housing 992 without interfering with operation of the actuator member 954 as described herein.

To operate the tenth example aerosol dispensing system 920, the container 930 and grip housing 992 are grasped such that the user's fingers can squeeze the trigger portion 994, thereby depressing the actuator member 954. The conduit outlet or outlet opening 946 is initially aimed at a test surface and the actuator member 954 is depressed to place the valve assembly 960 in the open configuration such that the pressurized material 936 forces some of the stored material 934 out of the container 930 and onto the test surface to form a test texture pattern. The test texture pattern is compared to the pre-existing texture pattern defined by the textured portion of the target surface. If the test texture pattern does not match the pre-existing texture pattern, one or both of the first and second adjustment members is/are adjusted to alter the spray pattern of the droplets of dispensed material 922.

The process of spraying a test pattern and adjusting the first and second adjustment members 972 and 982 is repeated until the test pattern formed by the dispensed material 922 corresponds to a desired texture pattern that substantially matches the pre-existing texture pattern.

Leaving the first and second adjustment members 972 and 982 as they were when the test texture pattern corresponded to the desired texture pattern, the aerosol dispensing system 920 is then arranged such that the conduit outlet or outlet opening 946 is aimed at the un-textured portion of the target surface. The trigger member 994 is again squeezed to place the valve assembly 960 in the open configuration such that the pressurized material 936 forces the stored material 934 out of the container 930 and onto the un-textured portion of the target surface to form the desired texture pattern on the un-textured portion of the target surface, perhaps overlapping slightly with the textured portion of the target surface. Since the desired texture pattern substantially matches the pre-existing texture pattern, the dispensed material forms a coating on the previously un-textured portion of the target surface in a desired texture pattern that substantially matches a physical appearance of the textured portion. One or more layers of primer and/or paint may next be applied over the cured layer of dispensed material.

The following Table K represents example ranges and dimensions for constructing a physical embodiment of a flow adjustment system that may be used as the example first flow adjustment system 970:

TABLE K

| Config. | Units | Example | First Range | Second Range |
|---|---|---|---|---|
| Fully Open | % Passageway | 100 | 95-100 | 90-100 |
| | Square Inches | .00385 | 0.00424- | 0.00578- |
| | | | 0.00347 | 0.00193 |
| Terminal | % Passageway | 0 | 0-16 | 0-20 |
| | Square Inches | 0.0000 | 0.00000- | 0.00000- |
| | | | 0.00041 | 0.00023 |

### III. Summary

Each of the embodiments described above contains a unique first adjustment system and one of several example second adjustment systems. Any one of the example second adjustment systems disclosed herein may be combined with any one of the unique first adjustment systems associated with each of the embodiments discussed above. Accordingly, the specific pairings of example first and second adjustment systems as described above are for illustrative purposes only, and, in one form, the principles of the present invention may be implemented by using any pair of example first and second adjustment systems whether that particular pairing is disclosed explicitly above or disclosed implicitly by reference in this Summary section.

Accordingly, the embodiments described herein may be embodied in other specific forms without departing from their spirit or essential characteristics. The described embodiments are to be considered in all respects only as illustrative and not restrictive. The scope of the invention is, therefore, indicated by the claims to be appended hereto rather than by the foregoing description. All changes which come within the meaning and range of equivalency of the claims are to be embraced within their scope.

TABLE A-4

| | | Commercial | | | | Second |
|---|---|---|---|---|---|---|
| Ref. | Material | Example | Function/Description | Example | First Range | Range |
| A | Diacetone | | Medium-evaporating, | 3.85 | 3.85 ± 5% | 3.85 ± 10% |
| | alcohol | | low odor solvent | | | |
| B | Propylene | | Slow evaporating, low | 2.31 | 2.31 ± 5% | 2.31 ± 10% |
| | Carbonate | | odor solvent | | | |
| C | Denatured | PM 6193-200 | Fast evaporating, low | 13.33 | 13.33 ± 5% | 13.33 ± 10% |
| | Ethanol | | odor solvent | | | |
| D | Resin | TB-044 resin (Dai) | Acrylic resin/binder | 4.93 | 4.93 ± 5% | 4.93 ± 10% |
| | | | (soluble in “weak” | | | |
| | | | solvents) | | | |
| E | Clay | Bentone 34 | Anti-settle/anti-sag clay | 1.26 | 1.26 ± 5% | 1.26 ± 10% |
| | Pigment | | pigment | | | |
| F | Fumed | Aerosil R972 | Anti-settle fumed silica | 0.08 | 0.08 ± 5% | 0.08 ± 10% |
| | Silica | | | | | |
| G | Dispersant | Byk Anti-Terra 204 | Dispersing aid | 0.51 | 0.51 ± 5% | 0.51 ± 10% |
| H | Calcium | MarbleWhite 200 | filler/extender | 33.87 | 33.87 ± 5% | 33.87 ± 10% |
| | carbonate | (Specialty Minerals) | | | | |
| I | Nepheline | Minex 4 | filler/extender | 33.87 | 33.87 ± 5% | 33.87 ± 10% |
| | syenite | | | | | |
| J | Denatured | PM 6193-200 | Fast evaporating, low | 4.00 | 4.00 ± 5% | 4.00 ± 10% |
| | Ethanol | | odor solvent | | | |
| K | Denatured | PM 6193-200 | Fast evaporating, low | 1.99 | 1.99 ± 5% | 1.99 ± 10% |
| | Ethanol | | odor solvent | | | |
| | | | | 100 | | |

TABLE A-5

| | | Commercial | | | | |
|---|---|---|---|---|---|---|
| Ref. | Material | Example | Function/Description | Example | First Range | Second Range |
| A | Diacetone | | Medium-evaporating, low | 13.73 | 5-15% | 0-20% |
| | alcohol | | odor solvent | | | |
| B | Propylene | | Slow evaporating, low odor | 2.11 | 1-3% | 0-5% |
| | Carbonate | | solvent | | | |
| C | Denatured | PM 6193-200 | Fast evaporating, low odor | 10.56 | 5-15% | 0-20% |
| | Ethanol | | solvent | | | |
| D | Resin | TB-044 resin | Acrylic resin/binder | 4.93 | 2-6% | 1-10% |
| | | (Dai) | (soluble in “weak” solvents) | | | |
| E | Clay | Bentone 34 | Anti-settle/anti-sag clay | 1.26 | 0.5-1.5% | 0.1-2.0% |
| | Pigment | | pigment | | | |
| F | Fumed | Aerosil R972 | Anti-settle fumed silica | 0.08 | 0-0.20% | 0-0.50% |
| | Silica | | | | | |
| G | Dispersant | Byk Anti-Terra | Dispersing aid | 0.51 | 0.3-0.7% | 0.1-1.5% |
| | | 204 | | | | |
| H | Calcium | MarbleWhite | filler/extender | 33.87 | 20-40% | 0-70% |
| | carbonate | 200 (Specialty | | | | |
| | | Minerals) | | | | |
| I | Nepheline | Minex 4 | filler/extender | 33.87 | 20-40% | 0-70% |
| | syenite | | | | | |
| J | Titanium | | White pigment | 0.00 | 0-5% | 0-20% |
| | Dioxide | | | | | |
| K | Calcined | Optiwhite | White extender pigment | 0.00 | 0-10% | 0-20% |
| | clay | | | | | |
| L | Hexane | | Very fast evaporating, low | 0.00 | 0-10% | 0-20% |
| | | | odor solvent | | | |

What is claimed is:

1. An aerosol dispensing system for dispensing stored material in a spray, comprising:
a container defining a chamber containing the stored material and pressurized material;
a conduit defining a conduit passageway having a conduit inlet and a conduit outlet, where the conduit inlet is arranged within the chamber and the conduit outlet is arranged outside of the chamber;
a first adjustment system arranged to vary a flow of stored material along the conduit passageway, where the first adjustment system is arranged between the conduit inlet and the conduit outlet; and
a second adjustment system arranged to vary the flow of stored material along the conduit passageway, where the second adjustment system is arranged between the first adjustment system and the conduit outlet.

2. An aerosol dispensing system as recited in claim 1, in which the stored material is texture material.

3. An aerosol dispensing system as recited in claim 1, in which the first adjustment system is arranged to define an effective cross-sectional area of the conduit passageway.

4. An aerosol dispensing system as recited in claim 1, in which the second adjustment system is arranged to define an effective cross-sectional area of the conduit outlet.

5. An aerosol dispensing system as recited in claim 3, in which the second adjustment system is arranged to define an effective cross-sectional area of the conduit outlet.

6. An aerosol dispensing system as recited in claim 1, in which the first adjustment system restricts flow of fluid along the conduit passageway.

7. An aerosol dispensing system as recited in claim 1, in which the first adjustment system allows pressure of the fluid material upstream of the first flow adjustment system to be greater than the pressure of the fluid material downstream of the first flow adjustment system.

8. An aerosol dispensing system as recited in claim 1, in which the conduit comprises:
a valve housing, and
an actuator structure; whereby
displacement of the actuator structure relative to the valve housing operates the valve system.

9. An aerosol dispensing system as recited in claim 1, in which the first adjustment system is configured selectively to allow and prevent flow of stored material along the conduit passageway.

10. An aerosol dispensing system as recited in claim 9, in which:
the actuator structure defines an actuator passageway;
the first adjustment system comprises a first adjustment member;
the actuator structure supports the first adjustment member such that
an adjustment portion of the first adjustment member extends into the actuator passageway, and
movement of the first adjustment member relative to the actuator structure causes of the adjustment portion to alter a cross-sectional area of the actuator passageway.

11. An aerosol dispensing system as recited in claim 10, in which the adjustment portion of the first adjustment member is shaped such that rotation of the first adjustment member relative to the actuator structure alters the cross-sectional area of the actuator passageway.

12. An aerosol dispensing system as recited in claim 10, further comprising a seal member arranged to prevent fluid flow between the first adjustment member and the actuator structure.

13. An aerosol dispensing system as recited in claim 8, in which the second adjustment system comprises a second adjustment member, where the actuator structure supports the second adjustment member such that movement of the second adjustment member relative to the outlet member alters an effective cross-sectional area of the conduit outlet.

14. An aerosol dispensing system as recited in claim 13, in which the second adjustment system further comprises an outlet member, where the second adjustment member deforms the outlet member to alter the effective cross-sectional area of the conduit outlet.

15. An aerosol dispensing system as recited in claim 14, in which the actuator structure defines a plurality of fingers that support the outlet member, where the second adjustment member deforms the fingers to deform the outlet member.

16. An aerosol dispensing system as recited in claim 1, in which the first adjustment system comprises a valve assembly operable in at least one partially open configuration between a fully open configuration and a closed configuration.

17. An aerosol dispensing system as recited in claim 16, further comprising an actuator member, in which:
the actuator member supports the second adjustment system;
the valve assembly comprises
a valve seat,
a valve member, and
a valve spring that biases the valve member towards the valve seat; and
the actuator member engages the valve member such that displacement of the actuator member towards the valve assembly displaces the valve member away from the valve seat against the bias applied by the valve spring.

18. An aerosol dispensing system as recited in claim 16, further comprising a stop member, where the stop member is supported to limit movement of the actuator member towards the valve assembly to limit movement of the valve member away from the valve seat.

19. A method of dispensing stored material in a spray, comprising the steps of:
arranging the stored material and pressurized material in a chamber;
arranging a conduit such that a conduit inlet is arranged within the chamber and a conduit outlet is arranged outside of the chamber;
varying a flow of stored material at a first location along the conduit passageway, where the first location is arranged between a conduit inlet defined by the conduit passageway and a conduit outlet defined by the conduit passageway; and
varying the flow of stored material at a second location along the conduit passageway, where the third location is arranged between the first location and the conduit outlet.

20. A method as recited in claim 19, in which the stored material is texture material.

21. A method as recited in claim 19, in which the step of controlling the flow of stored material at the second location comprises the step of altering an effective cross-sectional area of the conduit passageway at the second location.

22. A method as recited in claim 19, in which the step of controlling the flow of stored material at the second location comprises the step of restricting flow of fluid along the conduit passageway.

23. A method as recited in claim 19, in which the step of controlling the flow of stored material at the second location comprises the step of creating a pressure differential between the fluid material upstream of the second location and pressure of the fluid material downstream of the second location.

24. A method as recited in claim 19, in which the step of controlling the flow of stored material at the third location comprises the step of altering an effective cross-sectional area of the conduit outlet.

25. A method as recited in claim 19, in which the step of controlling flow of stored material at a first location along the conduit passageway comprises the step of selectively altering a first cross-sectional area at the first location of the conduit passageway to allow and prevent flow of stored material along a conduit passageway at the first location.

26. An aerosol dispensing system for dispensing stored material in a spray, comprising:
a container defining a chamber containing the stored material and pressurized material;
a conduit defining a conduit passageway having a conduit inlet and a conduit outlet, where the conduit inlet is arranged within the chamber and the conduit outlet is arranged outside of the chamber;
a valve assembly arranged selectively to allow and prevent flow of stored material along the conduit passageway;
a first adjustment member arranged to vary a flow of stored material along the conduit passageway, where the first adjustment member is arranged between the conduit inlet and the conduit outlet; and
a second adjustment member arranged to vary a flow of stored material along the conduit passageway, where the second adjustment member is arranged between the first adjustment member and the conduit outlet.

27. An aerosol dispensing system as recited in claim 26, in which the stored material is texture material.

28. An aerosol dispensing system as recited in claim 26, in which the first adjustment member is arranged to define an effective cross-sectional area of the conduit passageway.

29. An aerosol dispensing system as recited in claim 26, in which the second adjustment member is arranged to define an effective cross-sectional area of the conduit outlet.

30. An aerosol dispensing system as recited in claim 28, in which the second adjustment member is arranged to define an effective cross-sectional area of the conduit outlet.

31. An aerosol dispensing system as recited in claim 26, in which the first adjustment member restricts flow of fluid along the conduit passageway.

32. An aerosol dispensing system as recited in claim 26, in which the first adjustment member allows pressure of the fluid material upstream of the first flow adjustment member to be greater than pressure of the fluid material downstream of the first adjustment member.

33. An aerosol dispensing system as recited in claim 26, in which the conduit comprises:
a valve housing, where the valve assembly is arranged within the valve housing; and
an actuator structure; whereby
displacement of the actuator structure relative to the valve housing operates the valve assembly.

34. An aerosol dispensing system as recited in claim 26, in which the valve assembly is configured selectively to allow and prevent flow of stored material along the conduit passageway.

35. An aerosol dispensing system as recited in claim 34, in which:
the actuator structure defines an actuator passageway; and
the actuator structure supports the first adjustment member such that
an adjustment portion of the first adjustment member extends into the actuator passageway, and
movement of the first adjustment member relative to the actuator structure causes of the adjustment portion to alter a cross-sectional area of the actuator passageway.

36. An aerosol dispensing system as recited in claim 35, in which the adjustment portion of the first adjustment member is shaped such that rotation of the first adjustment member relative to the actuator structure alters the cross-sectional area of the actuator passageway.

37. An aerosol dispensing system as recited in claim 36, further comprising a seal member arranged to prevent fluid flow between the first adjustment member and the actuator structure.

38. An aerosol dispensing system as recited in claim 26, in which the actuator structure supports the second adjustment member such that movement of the second adjustment member relative to the outlet member alters an effective cross-sectional area of the conduit outlet.

39. An aerosol dispensing system as recited in claim 28, further comprising an outlet member, where the second adjustment member deforms the outlet member to alter the effective cross-sectional area of the conduit outlet.

40. An aerosol dispensing system as recited in claim 39, in which the actuator structure defines a plurality of fingers that support the outlet member, where the second adjustment member deforms the fingers to deform the outlet member.

41. An aerosol dispensing system as recited in claim 26, further comprising an actuator member, in which:
the actuator member supports the second adjustment member;
the valve assembly comprises
a valve seat,
a valve member, and
a valve spring that biases the valve member towards the valve seat; and
the actuator member engages the valve member such that displacement of the actuator member towards the valve assembly displaces the valve member away from the valve seat against the bias applied by the valve spring.

42. An aerosol dispensing system as recited in claim 41, further comprising a stop member, where the stop member is supported to limit movement of the actuator member towards the valve assembly to limit movement of the valve member away from the valve seat.

43. An aerosol dispensing system as recited in claim 27, in which the texture material comprises:
a first solvent having a first evaporation rate;
a second solvent having a second evaporation rate, where the second evaporation rate is lower than the first evaporation rate;
a third solvent having a third evaporation rate, where the third evaporation rate is higher than the first evaporation rate;
a binder;
a pigment;
fumed silica;
a dispersant;
a first filler extender;
a second filler extender.
